(19) United States
(12) Patent Application Publication
(10) Pub. No.: US 2026/0166493 A1
(43) Pub. Date: Jun. 18, 2026

(54) EXTRACTION MODULE AND METHODS FOR EXTRACTION OF A TARGET SPECIES

(71) Applicant: Kunin Technologies, Inc., Chattanooga, TN (US)

(72) Inventors: Kristof Balasanian, Mission Viejo (CA); Justin Walker, Midland, MI (US); Daniel Rau, Chattanooga, TN (US)

(21) Appl. No.: 19/420,088

(22) Filed: Dec. 15, 2025

Related U.S. Application Data
(60) Provisional application No. 63/735,041, filed on Dec. 17, 2024.
(60) Provisional application No. 63/736,160, filed on Dec. 19, 2024.
(60) Provisional application No. 63/744,433, filed on Jan. 13, 2025.
(60) Provisional application No. 63/904,133, filed on Oct. 23, 2025.

(51) Int. Cl. B01D 63/10; B01D 15/18; B01D 15/20; B01D 15/36; B01D 15/38; B01D 63/12; B01D 69/14

(52) U.S. Cl. CPC B01D 63/103; B01D 15/1896; B01D 15/203; B01D 15/361; B01D 15/3885; B01D 63/12; B01D 69/147; B01D 2313/143; B01D 2313/146; B01D 2313/40

(57) ABSTRACT

An extraction module includes an axial chamber positioned about a central axis; and a plurality of extraction leaves arranged in a stack. Each extraction leaf extends outward from the central axis in a radial curvature and includes a porous active layer, a first nonporous backing layer, a first porous spacer layer disposed between the porous active layer and the first nonporous backing layer, a second porous spacer layer disposed on the porous active layer on a side opposite the first porous spacer layer, and optionally, a second nonporous backing layer disposed on the second porous spacer layer on a side opposite the porous active layer. The extraction module can be particularly useful for extraction of a target species from a fluid.

### CROSS-REFERENCE TO RELATED APPLICATIONS

This application claims priority to U.S. Provisional Patent Application No. 63/904,133, filed on Oct. 23, 2025, U.S. Provisional Patent Application No. 63/744,433 filed on Jan. 13, 2025, U.S. Provisional Patent Application No. 63/736,160, filed on Dec. 19, 2024, and U.S. Provisional Patent Application No. 63/735,041, filed on Dec. 17, 2024, the contents of each of which are hereby incorporated by reference in their entirety.

### BACKGROUND

The present disclosure generally relates to an extraction module, for example, for use in the extraction of ions from fluids. Specifically, it pertains to a spiral-wound module designed to facilitate the efficient recovery of target ions through the use of adsorption, chelation, or ion exchange techniques.

Conventional fixed-bed ion-exchange and adsorption columns, while widely used, are frequently constrained by film-transfer limitations, intraparticle diffusion resistances, maldistribution, channeling, and elevated pressure drop across deep beds. These constraints manifest as elongated mass-transfer zones (MTZ), under-utilization of installed capacity at practical linear velocities, and unfavorable cost trade-offs which limit their utility for target separations of dilute ionic species.

Alternative “membrane chromatography” approaches have employed plate-and-frame fixtures that present thin active layers to flowing streams. While such architectures can shorten diffusion pathlengths, they often incur operational challenges including non-uniform flow distribution across large plates, mechanical limitations. and have larger spatial footprints that limit deployment in industrial process environments.

There accordingly remains a continuing need in the art for new apparatus architectures for extracting a target species from a fluid. It would be particularly advantageous to provide an apparatus architecture that can achieve improved efficiency, scalability, and cost-effectiveness.

### SUMMARY

An extraction module comprises an axial chamber having one or more openings, the axial chamber positioned about a central axis; and an extraction leaf, the extraction leaf comprising: a first porous active layer comprising a fibrous mat; a first nonporous backing layer; a first porous spacer layer disposed between the first porous active layer and the first nonporous backing layer; a second porous spacer layer disposed on the first porous active layer on a side opposite the first porous spacer layer; optionally, a second porous active layer comprising a fibrous mat disposed on the second porous spacer layer on a side opposite the first porous active layer; optionally, a third porous spacer layer disposed on the second porous active layer on a side opposite the second porous spacer layer; and optionally, a second nonporous backing layer disposed on the second porous spacer layer on a side opposite the first porous active layer or, when present, on the third porous spacer layer on a side opposite the second porous active layer; wherein the extraction leaf extends outward from the central axis along a radially curved trajectory.

Another aspect is an apparatus for extraction of a target species comprising the extraction module.

Another aspect is a method for extraction of a target species, the method comprising: providing a fluid comprising a target species to the extraction module or the apparatus described herein; wherein at least a portion of the target species is incorporated to the porous active layer.

The above described and other features are exemplified by the following figures and detailed description.

### BRIEF DESCRIPTION OF THE DRAWINGS

The following figures are exemplary embodiments wherein the like elements are numbered alike.

FIG. 1A is a cross-sectional end-view illustration of an extraction module according to an aspect of the present disclosure.

FIG. 1B is a cross-sectional side-view illustration of an extraction module according to an aspect of the present disclosure.

FIG. 1C is a cross-sectional side-view illustration of an extraction module according to an aspect of the present disclosure.

FIG. 1D is a cross-sectional side-view illustration of an extraction module according to an aspect of the present disclosure.

FIG. 2A is a cross-sectional end-view illustration of an extraction module according to an aspect of the present disclosure further illustrating an outward radial flow path

FIG. 2B is a cross-sectional side-view illustration of the extraction module of FIG. 2A according to an aspect of the present disclosure.

FIG. 2C is a cross-sectional side-view illustration of the extraction module of FIG. 2A according to an aspect of the present disclosure.

FIG. 2D is a cross-sectional side-view illustration of the extraction module of FIG. 2A according to an aspect of the present disclosure.

FIG. 3A is a cross-sectional illustration of an extraction leaf according to an aspect of the present disclosure.

FIG. 3B is a cross-sectional illustration of an extraction leaf according to an aspect of the present disclosure.

FIG. 3C is a cross-sectional illustration of an extraction leaf according to an aspect of the present disclosure.

FIG. 3D is a cross-sectional illustration of an extraction leaf according to an aspect of the present disclosure.

FIG. 4 is an exploded view of an extraction module according to an aspect of the present disclosure.

FIG. 5A is a cross-sectional illustration of a connection of an extraction leaf to the axial chamber according to an aspect of the present disclosure.

FIG. 5B is a cross-sectional illustration of a connection of an extraction leaf to the axial chamber according to an aspect of the present disclosure.

FIG. 5C is a cross-sectional illustration of a connection of an extraction leaf to the axial chamber according to an aspect of the present disclosure.

### DETAILED DESCRIPTION

Advances in membrane-based architectures, including spiral-wound designs, now present opportunities for more uniform flow profiles, enhanced mass transfer efficiency, and mechanical stability in targeted ion extraction from fluids. It would be particularly advantageous to provide an extraction device architecture that can deliver short diffusion pathlengths and high specific surface area without the maldistribution risks of packed beds, preserve controllable hydrodynamics over long pathlengths within a compact form factor, and realize high dynamic binding capacity per module volume and high extraction throughput at acceptable pressure drop and energy intensity.

Plate-and-frame (PF) modules have lower packing density than in spiral-wound elements, for example 100 to 400 m²/m³, because the flow channel height is larger than in spiral-wound elements, for example. This low packing density is considered a major disadvantage since it reduces the amount of functional media that can be embedded per unit volume. In addition, flat-sheet membranes experience greater mechanical stress for a given thickness than hollow-fiber membranes; hence PF modules often have thick membrane support layers to provide greater mechanical strength. Thicker membranes increase diffusion distances and further reduce the effective packing density. Together, these factors limit the extraction media mass inventory per module and restrict throughput.

By contrast, radially curved or spiral-wound (SW) modules can achieve high packing densities of, for example, 300 to 1000 m²/m³. Such an architecture provides membrane sheets that are wrapped around a central core with thin flow channels, allowing much larger membrane area within the same volume. The structure of alternating membrane, spacer, and adhesive layers function as a composite that provides mechanical support during operation. Because each envelope is supported on both sides by spacers and adjacent wraps, the laminate can be thin (tₘ) while still withstanding pressure drops typical of reverse osmosis (RO) elements. In addition, the cylindrical geometry distributes hoop stress and benefit from the materials' hoop tensile strength, enabling the module to operate at high flow rates and greater volumetric throughput.

The extraction media mass in a module can be approximated by m=ρₘP_{D}Vtₘ, where ρₘ is the polymer density, P_{D} is the packing density (membrane area per unit volume), V is the module volume, and tₘ is the effective membrane thickness.

Taking the ratio of the extraction media mass for spiral-wound and the plate-and-frame modules gives m_{SW}/m_{PF}≈(P_{D,SW}/P_{D,PF})(t_{m,SW}/t_{m,PF})(ρS_{W}/ρ_{PF}). Because P_{D,SW} is typically 500 m²/m³ versus 200 m²/m³ for PF, and spiral-wound media can be thinner due to its supportive laminate (t_{m,SW}<t_{m,PF}), the mass ratio is greater than 2 to 5, thus more extraction media mass can be embedded in the same housing volume. Therefore, at a fixed module volume, the spiral-wound design allows 2 to 5 times

more extraction media mass and provides integrated mechanical support, enabling greater volumetric throughputs and lower energy per unit separation than plate-and-frame modules. The high packing density and robust laminate make spiral-wound elements preferable for high-performance adsorption and ion exchange.

The present inventor has discovered an improved system that synergistically combines radially curved (e.g., spiral) geometries, and ion-selective materials to achieve superior efficiency, scalability, and cost-effectiveness. A significant improvement is therefore provided by the present disclosure.

Accordingly, an aspect of the present disclosure is an extraction module. The extraction module comprises an axial chamber having one or more openings (also referred to herein as a “perforated axial chamber”) positioned about a central axis. The extraction module further comprises an extraction leaf. The extraction leaf extends outward from the central axis along a radially curved trajectory. Stated another way, the extraction leaf is wound around the perforated axial chamber, for example in a spiral.

In an aspect, the radially curved trajectory can comprise a spiral, for example a constant-pitch spiral having uniform thickness across all radial and polar dimensions, i.e., before compression or as designed and assembled. When the extraction leaf extends from the central axis in a spiral configuration, the spiral can adopt of any suitable known spiral architecture. Spiral architectures include a linear Archimedean spiral, an exponential Archimedean spiral, a non-Archimedean spiral, a Gaussian spiral, Fermat's spiral, a hyperbolic spiral, or a logarithmic spiral. In a specific aspect, the spiral can be an Archimedean spiral. An Archimedean spiral, also referred to as an arithmetic spiral, is a spiral in which the radius increases by a constant value with each successive revolution of the spiral. Stated another way, the radius of the spiral increases linearly moving outward along the length of the spiral.

The spiral of the extraction module can have any suitable number of revolutions, for example at least 1 revolution, or at least 2 revolutions, or 1 to 10 revolutions, e.g., 1, 2, 3, 4, 5, 6, 7, 8, 9, or 10 revolutions. In some aspects, the spiral of the extraction module can comprise up to 10,000 revolutions, or up to 5,000 revolutions, or up to 1,000 revolutions, or up to 500 revolutions, or up to 100 revolutions. It will be understood that the number of revolutions can be dictated by the thickness of the extraction leaf thickness.

In a specific aspect, the extraction leaf can have a uniform thickness and the resulting spiral can be a linear Archimedean spiral. In some aspects, the spiral can have constant inter-turn spacing. In some aspects, the spiral can be a linear Archimedean spiral having constant pitch, a modified exponential spiral, or a spiral geometry configured to maintain uniform thickness across all radial and polar dimensions.

The axial chamber of the extraction module can be a permeable chamber extending along the central axis of the extraction module, wherein the permeability arises from the presence of the one or more openings on the chamber. Preferably, the axial chamber has a cylindrical or tubular shape. The dimensions of the chamber can vary depending on the application. In some aspects, the chamber can have a channel width of 1 millimeter (mm) to 100 centimeters (cm). Within this range, the chamber can have a diameter of at least 5 mm, or at least 10 mm, or at least 50 mm, or at least 100 mm, or at least 500 mm. Also within this range, the chamber can have a diameter of at most 75 cm, or at most 50 cm, or at most 25 cm, or at most 10 cm, or at most 5 cm, or at most 1 cm. Similarly, the length of the perforated axial chamber is not particularly limited and can vary depending on the application of the extraction module. In some aspects, the chamber may have a length of 1 cm to 5 meters (m), or 10 cm to 1 m, or 10 cm to 500 cm, or 10 cm to 100 cm.

The axial chamber can generally be prepared from any suitable material provided that the material is inert to or otherwise compatible with the operating conditions of the extraction module, and the fluids to be provided to the extraction module. Preferably, the material is impermeable to the fluids to be used in the extraction module such that fluid flow through the wall of the chamber is permitted only through the openings incorporated into the chamber wall as further described herein. Preferably, the axial chamber is not prepared from a porous material.

In an aspect, the axial chamber can be prepared from a material comprising a plurality of perforations or openings along the chamber. The perforations or openings are formed in a wall of the surface of the axial chamber and allow an inner space and an outer space to communicate (e.g., fluidly) with each other. Stated another way, the perforation or opening penetrates the wall surface of the axial chamber, and provides fluid communication between the extraction leaves and the inside of the axial chamber. In particular, the spacer layers of the extraction leaves may be in fluid communication with the inside of the axial chamber.

The openings of the axial chamber can generally have any suitable shape, and can be rectilinear, curvilinear, or any combination thereof. The openings can include one or more edges or corners, which may be sharp, rounded, radiused, filleted, or chamfered, in any combination. Non limiting examples include square, square with filleted edges and corners, rectangular, rectangular with rounded corners, circular, triangular, diamond, irregular shape, elliptical, thin-slits or the like. In an aspect, the axial chamber can comprise one or more openings, wherein each opening is configured as a thin slit that extends along some or all the length of the axial chamber. Each opening is configured to fluidically couple a membrane leaf permeate path, or leaf to tube interface region, to the axial chamber or the central axial chamber. Exemplary, non-limiting examples of suitable shapes for the openings of the axial chamber are depicted in FIG. 4.

The axial chamber comprises one or more openings. In some aspects, the axial chamber comprises a plurality of openings. For example, the number of openings can be 2 or more, for example 4 or more. The upper limit of the number of openings is not particularly restricted and can be, for example, 100, or 75, or 60, or 50, or 40, or 30. Each opening of the plurality of openings may or may not be identical in shape or dimensions.

The openings can be arranged circumferentially around the axial chamber. The openings may or may not be arranged (e.g., spaced) in equal intervals. The openings can be arranged longitudinally along the length of the axial chamber, and may or may not be arranged (e.g., spaced) at equal intervals in the longitudinal directions. In some aspects, the openings may be arranged in a grid pattern, a staggered pattern, or an irregular pattern. Preferably the section of the surface of the axial chamber that extends between adjacent extraction leaves may have no perforations.

The openings can be or any suitable size, for example ranging from 0.1 millimeter to 10 centimeters in opening width. The openings can have an average length of, for example, 1 mm to 10 cm. In some aspects, the openings can be substantially circular, e.g., where the width of the opening is approximately equal to the length. Preferably, the openings are positioned along the axial chamber to align with a point of attachment of a spacer layer of the extraction leaf to the axial chamber. The number, position, and spacing of the openings can therefore vary based on the number of extraction leaves in contact with the axial chamber. In some aspects, the distance between two adjacent openings can be, for example, 500 mm or less, or 250 mm or less, or 100 mm or less, or 50 mm or less, or 10 mm or less. In some aspects, it can be preferable for the dimensions of the openings to match the length and width of the spacer layer from which fluid exits during operation of the module. Stated another way, in an aspect the fluid connection between the spacer layer and the central axial chamber is flush and sealed so as to prevent undesirable fluid leakage.

In some aspects, the openings can be graded along the axial chamber to manage local hydraulic conditions and equalize distribution to and from the spacer layers. Thus, an opening configured as a slit may have a variable width w(z) as a function of axial position z (and/or circumferential position θ), for example tapering or stepping from 0.1 to 10 mm along the length of the chamber, thereby compensating for transverse pressure-drop differentials that arise across successive wraps of the spiral-wound leaves. Likewise, perforations configured as discrete holes may have a variable diameter d(z) or variable pitch p(z) along the tube, for example 0.1 to 10 mm diameter with a local open-area fraction of 1 to 40%, adjusted monotonically or in zones to maintain a target axial pressure profile and near-uniform radial flux. The grading can be continuous (e.g., linear, exponential, logarithmic) or segmented (multi-zone step changes), and can be combined with variable slit length, slot density, or stagger patterns so that each extraction leaf connection region exhibits a specified cumulative open area. In some aspects, the openings can increase in width and diameter or count with increasing distance from a feed or product header to offset cumulative head losses, while in other aspects the grading can be reversed to meter flow for purge, rinse, or regeneration sequences. The graded features, when present, can be produced by drilling, laser cutting, water-jetting, photochemical etching, electrical-discharge machining, or additive/subtractive manufacturing, and may optionally incorporate removable orifices, bushings, or grommets to fine-tune local hydraulic resistance or to provide wear protection.

In some aspects, the openings can be provided at a 90° angle relative to the circumferential plane such that an extraction leaf can be directly inserted into the opening normal to the surface of the axial chamber. In some aspects, the openings can be provided at an angle, for example an angle that is greater than 0° and less than 90°, such that an extraction leaf can be directly inserted into the opening at a desired angle. In some aspects, the axial chamber can be provided having one or more protrusions extending from an opening that can be used as a connection point to an extraction leaf. The openings are further described below in reference to the Figures.

The openings can be provided by any suitable methods for creating an opening, for example, by drilling, lathing, laser cutting, or the like into a solid material.

Exemplary inert materials that can be used to form the axial chamber can include, but are not limited to, glass, polymers (e.g., acrylonitrile-butadiene-styrene copolymer, polyolefins such as polypropylene, polyethylene, fluorinated polymers such as polytetrafluoroethylene), a fiber reinforced plastic (FRP), ceramics, titanium, stainless steel, or the like, or a combination thereof. In an aspect, the axial chamber can be prepared from any of the inert materials described herein in the context of the nonpermeable backing layer.

The extraction module comprises an extraction leaf extending outward from the central axis along the radially curved trajectory. In some aspects, a single extraction leaf may be present. In some aspects, the extraction module can comprises a plurality of extraction leaves (e.g., 2 or more), wherein the plurality of extraction leaves are arranged in a stack, and the stack is wound around the axial chamber in a radially curved trajectory. In some aspects, the extraction module can comprise 1 to 50 extraction leaves, for example 2 to 50 leaves, or 2 to 40 extraction leaves, or 2 to 30 extraction leaves, or 2 to 20 extraction leaves, 2 to 10 extraction leaves, or 2 to 8 extraction leaves, or 2 to 6 extraction leaves, or 3 to 6 extraction leaves.

In an aspect, each extraction leaf comprises a porous active layer, a first nonporous backing layer, a first porous spacer layer disposed between the porous active layer and the first nonporous backing layer, a second porous spacer layer disposed on the porous active layer on a side opposite the first porous spacer layer, and optionally, a second nonporous backing layer disposed on the second porous spacer layer on a side opposite the porous active layer. In some aspects, the extraction leaf can optionally comprise a second porous active layer disposed on the second porous spacer layer on a side opposite the first porous active layer, a third porous spacer layer disposed on the second porous active layer on a side opposite the second porous spacer layer, and a second nonporous backing layer disposed on the second porous spacer layer on a side opposite the first porous active layer or, when present, on the third porous spacer layer on a side opposite the second porous active layer.

When a plurality of extraction leaves are present in the extraction module, the target species of each leaf can be individually selected. For example, in an aspect each extraction leaf of the extraction module may be selective for a an individually selected target species. In an aspect, a first extraction leaf of the extraction module can be selective for a first target species, a second extraction leaf of the extraction module can be selective for a second target species, and a third extraction leaf of the extraction module can be selective for a third target species, etc. In some aspects, each leaf can be selective for multiple target species In an aspect the first extraction leaf can be selective for the first and the second target species.

The porous active layers can each independently comprise a fibrous mat. As used herein, a fibrous mat refers to a nonwoven structure composed of a plurality of fibers that are physically entangled or otherwise associated to form a cohesive, sheet-like network. The fibers may be continuous or discontinuous and can vary in diameter, for example, from the nanometer to the micrometer scale. In some aspects, the polymeric fibers can have an average diameter of less than or equal to 10 micrometers.

The fibers may be formed from one or more polymeric materials, such as thermoplastic, thermosetting, or curable polymers. The polymers can include natural and synthetic polymers. Exemplary polymers can include, but are not limited to, styrenic polymers, (meth)acrylic polymers, (meth)acrylamide polymers, polyarylether ketones; more specifically polystyrene, polyacrylonitrile, polyacrylic acid, polymethyl methacrylate, polyether ether ketone, polysulfone, poly(4-vinyl pyridine), polyacrylamide, cellulose, dextran, chitosan, poly(vinyl benzyl chloride), and the like, or a combination thereof.

The fibers may comprise chemically crosslinked polymer networks, including inter-chain, intra-chain, or grafted crosslinks, to exhibit controlled swellability, dimensional stability, and chemical resistance under process conditions. In some aspects, the fibers can comprise crosslinked styrenic polymer networks, including polystyrene crosslinked with divinyl aromatic monomers, such as divinylbenzene, to form a three-dimensional polymer network. The degree of crosslinking may be selected to tune solvent resistance, mechanical integrity, ion-exchange capacity retention, and volumetric swelling behavior of the fibers. Crosslinking may be achieved through thermal initiation, chemical initiation, radiation, or post-fabrication curing, and may occur during fiber formation or as a subsequent treatment.

In some aspects, the fibrous mat of the porous active layer comprises polymer nanofibers having an average fiber diameter of 50 nanometers to 5 micrometers, or 100 nanometers to 1 micrometer, or 200 to 800 nanometers, as determined by scanning electron microscopy (SEM) image analysis. Such fiber diameters correspond to specific surface areas between approximately 50 m²/g and 1,000 m²/g, depending on porosity, thereby providing enhanced mass transfer and adsorption kinetics within the porous active layer.

In an aspect, the fibrous mat is capable of selectively incorporating a particular ion, for example due to the presence of one or more functional groups present on the polymer fibers of the mat. Thus, in some aspects, the polymer of the fibrous mat can be functionalized to impart chemical reactivity or selectivity. For example, the polymers may include or be modified to include functional groups capable of ion exchange, chelation of metal ions, or adsorption of ionic species. Exemplary functional or reactive groups can include, but are not limited to, hydroxyl groups, phenolic groups, nitrile groups, carboxylic acid groups, ester groups, sulfonate groups, pyridine groups, amine groups, amide groups, and the like, or a combination thereof. Functional groups can be imparted to the polymeric material before or after forming the fibrous mat, and can be grafted to the polymer chains, for example using UV-assisted grafting. In some aspects, a monomer may be functionalized, and the functionalized monomer can be subsequently polymerized to provide the corresponding polymer comprising the desired functional group on at least a portion of the repeating units of the polymer chain. It is noted that in cases where the polymer selected inherently includes a functional group capable of participating in the desired ion extraction mode, further functionalization of the fibrous mat may be avoided.

In a specific aspect, the porous active layer can comprise a functionalized fibrous mat capable of ion extraction by ion exchange (i.e., the fibrous mat can comprise a fibrous ion exchange material). In an aspect, the fibrous ion exchange material can be a cation exchange material, for example comprising sulfonic acid groups (e.g., polystyrene sulfonate), carboxylic acid groups, acrylic acid groups, or the like.

In some aspects, the porous active layer can comprise a functionalized fibrous mat capable of ion extraction by chelation (i.e., the fibrous mat can comprise a fibrous material comprising a chelating group). Exemplary chelating resins for forming the fibrous mat can include, for example, a resin comprising iminodiacetate groups, thiol groups, aminophosphonate groups, or the like. Functional polymers can also be used as ion selective materials. In an aspect a functional polymer can comprise one or more repeating units bearing a chelating group or an ion exchange group.

In some aspects, the fibrous mat can comprise an ion exchange group. As used herein, “ion exchange group” refers to a pendant ionic or ionizable moiety affixed directly or via a linker to a polymer backbone of the fibrous mat, which, under operating conditions of the extraction module, bears a formal charge and reversibly exchanges counter-ions with a contacting fluid. In some aspects, the ion-exchange functional group can comprise a cation-exchange group (anionic in their salt form, e.g., sulfonic acid/sulfonate (—SO₃H/—SO₃⁻), perfluorosulfonic acid; sulfopropyl; bis(sulfonyl)imide and sulfonyl(trifluoromethylsulfonyl)imide acids; sulfonic acid ester precursors convertible thereto; carboxylic acid/carboxylate (—CO₂H/—CO₂⁻), including acrylic, methacrylic, maleic, itaconic; phosphonic/phosphonate (—PO(OH)₂/—PO₃²⁻) and phosphinic/phosphinate; phenolic (including catechol/tannic/novolak-type) where deprotonated under use conditions; sulfoalkyl (e.g., —(CH₂)ₙ—SO₃H); and combinations thereof); an anion-exchange groups (cationic in their salt form, e.g., quaternary ammonium (—N⁺R₄), quaternary phosphonium (—P⁺R₄), quaternary pyridinium, sulfonium (—S⁺R₃); imidazolium, pyridinium, quinolinium, morpholinium, piperidinium and other oniums; primary/secondary/tertiary/poly amines (protonated under use conditions), including dialkyl- and trialkyl-aminoalkyl; amidinium/guanidinium; poly(ionic liquid) motifs bearing cationic backbones; and combinations thereof), or amphoteric/mixed-mode groups that simultaneously comprise cation- and anion-exchange functionality or exhibit pH-dependent charge inversion (e.g., betaine, carboxybetaine, sulfobetaine, phosphobetaine, zwitterionic amine-acid pairs, and multi-site constructs such as tertiary amine+sulfonate on a common tether).

In an aspect, the fibrous mat can comprise a chelating or affinity ligand. Exemplary chelating or affinity groups include, but are not limited to, amidoxime; hydroxamic acid; oxime; catechol/tannic/phenolic; salicylaldoxime; iminodiacetate (IDA); nitrilotriacetate (NTA); EDTA/EGTA/DTPA analogs; aminophosphonate; phosphonic/phosphinic acid; hydroxypyridinone/hydroxypyridone; diglycolamide (DGA), tetraoctyldiglycolamide (TODGA); carbamoylmethylphosphine oxide (CMPO); trialkylphosphine oxide (e.g., TOPO); β-diketone/enol; crown ether; cryptand; calixarene; resorcinarene; pillar[n]arene; porphyrin/salen/salophen; N-Methyl-D-glucamine (NMDG); thioether; thiol; dithiocarbamate; isothiouronium; xanthate; thiourea/urea/guanidinium (anion receptors via H-bonding/ion pairing); thiosalicylate; thiosemicarbazide; imidazolium/pyridinium/phosphonium ionic-liquid moieties; pyridine/diimine; polyamine; tris(2-aminoethyl)amine; bis(2-picolyl)amine; picolylamine; 3,4,5-trihydroxybenzoate; geminal diphosphonic; 8-hydroxyquinoline; 2-mercaptobenzothiazole; poly(4-vinylpyridine); 1,10-phenanthroline; acetylacetone; di(2-ethylhexyl)phosphoric acid (DEHPA); and combinations thereof. Mentioned is PC88A, a branched C₈ alkyl phosphonic acid monoester, chemically known as 2-ethylhexyl phosphonic acid mono-2-ethylhexyl ester.

In an aspect, the fibrous mat can comprise a sorbent phase comprising a particulate or continuous adsorbent such as silica; alumina; titania; zirconia; iron(III) oxyhydroxides (e.g., FeOOH, Fe₂O₃), manganese oxides; hydrotalcite/LDH; zeolites; activated carbon; carbon black; graphene/graphite/CNT; polymeric adsorbents (styrene-DVB, methacrylate, polyamide, polyimide); Prussian-blue analogs; ion-sieve materials (e.g., lithium manganese oxide sieves; titanium-based sodium sieves); metal nanoparticles or salts (Ag, Cu, Zn, Pd) for reactive scavenging; metal-organic frameworks (MOFs); covalent organic frameworks (COFs); polymer-in-membrane/extractant-impregnated polymer (PIM/EIP) phases; molecularly imprinted polymers (MIPs); and combinations thereof.

In some aspects, the fibrous mat can be produced by electrospinning, in which a polymer solution or melt is subjected to an electrostatic field to form fine fibers that are collected as a nonwoven layer. Other fiber-forming methods may also be employed, such as melt blowing, solution blowing, or phase separation techniques.

The resulting fibrous mats may exhibit high porosity, large surface area, and interconnected pore structure, which can be advantageous for ion extraction. The morphology and properties of the fibrous mat may be tailored by varying parameters such as polymer concentration, solvent system, applied voltage, collection distance, or post-treatment conditions.

In some aspects, in addition to the fibrous mat, the porous active layer(s) can further comprise a binder, a conductive additive, or both. In some aspects, each porous active layer consists of the fibrous mat.

In some aspects, the fibrous mat of the porous active layer can provide a desired basis weight, for example at least 0.1 milligrams per square centimeter (mg/cm²), or at least 1 mg/cm². In some cases, the fibrous mat of the porous active layer can provide a desired basis weight of least 0.2 mg/cm², or at least 0.5 mg/cm², or at least 1 mg/cm², or at least 2 mg/cm², at least 3 mg/cm², at least 5 mg/cm², at least 10 mg/cm², at least 15 mg/cm², at least 20 mg/cm², at least 25 mg/cm², at least 30 mg/cm², at least 35 mg/cm², at least 40 mg/cm², at least 45 mg/cm², at least 50 mg/cm², at least 55 mg/cm², at least 60 mg/cm², at least 65 mg/cm², at least 70 mg/cm², at least 75 mg/cm², at least 80 mg/cm², at least 85 mg/cm², at least 90 mg/cm², at least 100 mg/cm², at least 110 mg/cm², at least 120 mg/cm², at least 150 mg/cm², or at least 200 mg/cm². In some cases, the fibrous mat of the porous active layer can provide a desired basis weight of no more than 10,000 mg/m² or no more than 7,500 mg/cm², or no more than 5,000 mg/cm², or no more than 2,500 mg/cm², or no more than 1,000 mg/cm², or no more than 900 mg/cm², or no more than 800 mg/cm², or no more than 700 mg/cm², or no more than 600 mg/cm², or no more than 500 mg/cm², or no more than 400 mg/cm², or no more than 300 mg/cm², or no more than 200 mg/cm², or no more than 150 mg/cm², no more than 120 mg/cm², no more than 110 mg/cm², no more than 100 mg/cm², no more than 90 mg/cm², no more than 85 mg/cm², no more than 80 mg/cm², no more than 75 mg/cm², no more than 70 mg/cm², no more than 65 mg/cm², no more than 60 mg/cm², no more than 55 mg/cm², no more than 50 mg/cm², no more than 45 mg/cm², no more than 40 mg/cm², no more than 35 mg/cm², no more than 30 mg/cm², no more than 25 mg/cm², no more than 20 mg/cm², no more than 15 mg/cm², no more than 10 mg/cm², no more than 5 mg/cm², no more than 3 mg/cm², no more than 2 mg/cm², or no more than 1 mg/cm². Combinations of any of these ranges are also possible.

In some aspects, the fibrous mat of the porous active layer can exhibit a specific surface area of 5 to 1,000 m²/g, or 100 to 500 m²/g, as determined by Brunauer-Emmett-Teller (BET) analysis using nitrogen adsorption, preferably as set forth in ISO 9277. The combination of basis weight and specific surface area can provide an effective interfacial area of at least 0.5 to 10 m²/cm² of projected area, enhancing ion-exchange kinetics and adsorption efficiency.

The porous active layer can further comprises a polymeric binder. The binder can assist in formation of the porous active layer, for example by binding components such as the fibrous mat and other components (if present). Any suitable polymeric binder can be used. In some aspects, the polymeric binder can comprise polyvinylidene fluoride, polypyrrole, polyaniline, polyethylene oxide, cellulose, a styrene-butadiene rubber, a polyacrylonitrile, a polyamide (e.g., Nylon), polyvinyl alcohol, polytetrafluoroethylene, polystyrene, polymethyl methacrylate, a polyimide, polycaprolactone, or a combination thereof. In an aspect, the polymeric binder can comprise a biodegradable polymer such as polylactic acid, polycaprolactone, chitosan, or cellulose.

In some aspects, a conductive polymer can be preferred, for example polypyrrole, polyaniline, or the like, or a combination thereof. In some cases, the polymeric binder preferably comprises a hydrophobic polymer, for example a polymer having an air-water contact angle of greater than 90°, greater than 100°, greater than 110°, greater than 120°, greater than 130°, or other contact angles such as any of those described herein. Additional non-limiting examples of hydrophobic polymers include polytetrafluoroethylene (PTFE), fluoroethers, fluorinated ethylene propylene (FEP), silicone, polyvinylidene fluoride (PVDF), polypropylene, polystyrene, polyethylene terephthalate (PET), or the like. In some aspects, silicone or silicone polymers may be used. For example, the silicone polymer may be a cross-linked silicone polymer, and or the silicone or silicone polymer may be infused with silicone oil.

The binder can be present in the porous active layer in an amount of, for example, at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, or at least 75 wt %, each based on the total weight of the porous active layer. In some cases, the binder may be present at no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, or no more than 1 wt %, each based on the total weight of the porous active layer. Combinations of any of these are also possible. For example, a binder may be present at a concentration of 5 to 80 wt %, or 30 to 50 wt %, or 20 to 45 wt %.

The porous active layer can optionally further include various additives. In some aspects, the porous active layer can comprise a conductive additive. The presence of a conductive additive can be particularly advantageous if the extraction module is to be operated using an electric current to facilitate incorporation of the target species. Thus, in some aspects, when the extraction module is to be operated electrically, the porous active layer can function as an electrode.

Exemplary conducting additives can include, but are not limited to, carbon particles, e.g., coke particles, carbon black, Vulcan carbon particles, or the like. Non-limiting examples of suitable conductive materials include graphite, titanium, activated carbon, sulfonated carbon, or the like. As another example, the conducting material may include a metal (for example, present as a metal powder). Non-limiting examples include titanium, platinum, silver, zirconium, tin, copper, gold, zinc, stainless steel. As yet another example, the conducting material can include glass microspheres, for example, metal coated glass microspheres (such as the metals described herein). In still another example, a conductive material may include a conductive carbon material. Non-limiting examples include carbon black, carbon nanotubes, graphene, graphene oxide, and the like, or a combination thereof. Yet other examples include a conductive polymer. Non-limiting examples of conductive polymers include poly(3,4-ethylenedioxythiophene) polystyrene sulfonate (PEDOT:PSS), polypyrrole, polythiophene, polyaniline (PANI), polythiophene, and the like. Still other examples of conducting materials include conductive ceramic. Non-limiting examples of conductive ceramics include indium tin oxide (ITO), niobium titanium oxide (NTO), or the like. In addition, one or more conductive materials may be present, including but not limited to any of the conductive materials described herein.

In some aspects, when present, the conductive additive comprises carbon, preferably graphitic carbon, carbon black, graphene oxide, reduced graphene oxide, carbon nanotubes, Vulcan carbon, petroleum coke, or a combination thereof.

When present, the conductive additive can be present in the porous active layer in an amount of least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, or at least 75 wt %, each based on the total weight of the porous active layer. In some aspects, the conductive additive may be present at no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, or no more than 1 wt %, each based on the total weight of the porous active layer. Combinations of any of these are also possible. For example, a conductive additive may be present at a concentration of 5 to 80 wt %, or 30 to 50 wt %, or 20 to 45 wt %.

In some aspects, the porous active layer can optionally further comprise a crosslinker. Preferably, the crosslinker is capable of providing crosslinks between polymer fibers of the fibrous mat. Exemplary crosslinkers can include those comprises two or group groups comprising ethylenic unsaturation, for example divinyl benzene, ethylene glycol dimethacrylate, allyl methacrylate, trimethylolpropane trimethacrylate, methylene bisacrylamide, or the like, or a combination thereof. In some aspects, suitable crosslinkers can include epichlorohydrin, formaldehyde, or an alkylene glycol, such as ethylene glycol. When present, the crosslinker can be included in the precursor solution comprising the polymeric material being used to provide the fibrous mat of the porous active layer, and the porous active layer can be provided by electrospraying or a co-electrospraying-electrospinning process of the solution including the crosslinker to provide a nonwoven material

The porous active layer can optionally further comprise a coating disposed thereon. The coating can provide a variety of functions, for example to enhance wettability, alter ionic or electronic conductivity, improve (electro)chemical stability, or the like or a combination thereof. In an aspect, the coating can be a hydrophilic coating, which can improve the wettability of the porous active layer. Exemplary hydrophilic materials for providing a hydrophilic coating can include but are not limited to hydrophilic polymers such as polyurethane, carboxymethyl cellulose (CMC), styrene-butadiene rubber (SBR), polyethylene glycol (PEG), sulfonated tetrafluoroethylene (e.g., Nafion), acrylonitrile copolymer latex (e.g., LA133), polyacrylic latex, polyamide (PA), poly(methyl methacrylate) (PMMA), polyvinyl alcohol (PVA), polyacrylonitrile (PAN), polyvinyl chloride (PVC), polyethylene terephthalate (PET), or the like. In some aspects, a hydrophilic coating can comprise a hydrophilic inorganic ceramic, for example silica, alumina, zirconia, titania, silicon carbide, ceria, perovskites, metal oxides, titanium oxide, tungsten oxide, tin oxide, and zirconium oxide, or the like, or combinations thereof.

The coating, when present, can cover at least 10%, at least 20%, at least 30%, at least 40%, at least 50%, at least 55%, at least 60%, at least 65%, at least 70%, at least 75%, at least 80%, at least 85%, at least 90%, at least 95%, or at least 99% of an outer surface of the porous active layer. In some aspects, the coating can cover the entire outer surface of the porous active layer. In some aspects, no coating is present on the surface of the porous active layer.

The coating, when present, may be of any thickness on the porous active layer. For instance, the coating may have an average thickness on the porous active layer of at least 0.000001 mm, or at least 0.00001 mm, or at least 0.0001 mm, or at least 0.01 mm, or at least 0.1 mm, at least 0.2 mm, at least 0.3 mm, at least 0.5 mm, at least 1 mm, at least 2 mm, at least 3 mm, at least 5 mm, at least 10 mm, at least 20 mm, at least 30 mm, at least 50 mm, or at least 100 mm.

Other suitable additives which may be included on or in the porous active layer can include, for example, biocides, corrosion inhibitors, anti-fouling agents, antioxidants, a pH buffer, reinforcing additives for mechanical stability, and the like, or a combination thereof, for example as described in International Patent Application No. PCT/US2024/012499, the contents of which is hereby incorporated by reference in its entirety for all purposes.

The porous active layer comprises a plurality of pores. For example, the porous active layer can have a porosity of at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, and/or no more than 90%, no more than 85%, no more than 80%, no more than 75%, no more than 70%, no more than 65%, no more than 60%, no more than 55%, no more than 50%, no more than 45%, no more than 40%, no more than 35%, no more than 30%, no more than 25%, no more than 20%, no more than 15%, no more than 10%, or no more than 5%, determined as a volume fraction of the material forming the active layer. In some aspects, the porous active layer can have a porosity of at least 40%, at least 45%, at least 50%, at least 55%, at least 60%, at least 65%, at least 70%, at least 75%, at least 80%, at least 85%, at least 90%, and/or no more than 90%, no more than 85%, no more than 80%, no more than 75%, no more than 70%, no more than 65%, no more than 60%, no more than 55%, no more than 50%, determined as a volume fraction of the material forming the active layer.

For instance, a porous active layer may have a porosity of 20 to 25%, or 10 to 30%, or 35 to 45%, or 30 to 40%, or 25 to 70%, on a volumetric basis.

The pores of the porous active layer can generally be of any size, shape, or tortuosity. For example, in some cases, the pores may have an average cross-sectional dimension of less than 1 mm, less than 300 micrometers, less than 100 micrometers, less than 30 micrometers, less than 10 micrometers, less than 3 micrometers, less than 1 micrometer, less than 300 nm, less than 100 nm, less than 30 nm, or less than 10 nm. Porosity can be determined using standard porosimetry techniques (e.g., mercury intrusion porosimetry, cyclic porosimetry, gas absorption techniques, etc.) known to those of ordinary skill in the art.

The porosity of the porous active layer can allow a fluid to enter and pass through the pores, and thus can allow the target species to incorporate into (or be removed from) the porous active layer, for example due to the increased available surface area. The porosity can therefore allow for fast mass transfer of target species deep into the porous active layers.

The thickness of the porous active layer is not particularly limited and can depend on the overall size of the extraction module. For example, the porous active layer can have a thickness of 1 to 1000 mm. Other thicknesses are also contemplated. In some aspects, the porous active layer can have a surface area of 1 to 10000 square meters (m²).

In some aspects, the porous active layer can be prepared by any suitable methods. In an aspect, the porous active layer can be provided by electrospinning, and thus can comprise a plurality of fibers. The fibers can be woven or nonwoven. In some aspects, hollow fibers can be provided. Due to the shape of the fibers, pores can exist within the porous active layer through which a fluid can flow. In some aspects, the porous active layer can be provided by electrospraying or a co-electrospraying-electrospinning process.

In some aspects, it can be advantageous to include a porogen to provide additional pores and/or enhance the specific surface area of the porous active layer. Upon removal of the porogen, the desired porosity can be provided. Exemplary porogens can include polyethylene glycol (PEG), sucrose, ammonium carbonate, sodium chloride or other salts, chloride salts, sulfate salts, silica, carbonate salts, polystyrene, polyvinyl pyrrolidone (PVP), polyvinylalcohol (PVA), polymethacrylate (PMA), polyacrylicacid (PAA), or the like. Porogens can be subsequently removed, e.g., by heating to oxidize the porogen, or by adding water to dissolve the porogen. When present, a porogen can be included in the precursor solution comprising the polymeric material being used to provide the fibrous mat of the porous active layer, and the porous active layer can be provided by electrospraying or a co-electrospraying-electrospinning process of the solution including the porogen to provide a nonwoven material. Other methods of introducing porosity can include laser ablation, additive manufacturing, mechanical patterning, or the like.

The porous active layer can optionally further comprise a support material, which can be a mesh, a cloth, a porous current collector, or other reinforcing structure. The porous active layer can be in contact with the support material. In some aspects, the support material may be embedded in the porous active layer. In some aspects, the support material can be disposed on a surface of the porous active layer.

In addition to the porous active layer, the extraction module further comprises a first and optionally a second nonporous backing layer. The first and second nonporous backing layers can be the same or different in composition or thickness. In a specific aspect, the first and second nonporous backing layers are compositionally the same. The nonporous backing layers are substantially nonporous and thus nonpermeable to a fluid. For example, the nonporous backing layers can have a porosity of less than 1%, preferably a porosity of 0%. In an aspect, the extraction leaf comprises the first nonporous backing layer. In an aspect, the second nonporous backing layer is present and is on the second porous spacer layer on a side opposite the first porous active layer. In an aspect, the second nonporous backing layer is present and is on a third porous spacer layer on a side opposite a second porous active layer.

The nonporous backing layers can generally be made from any suitable nonporous material, provided that the material is also inert to a fluid to be introduced into the extraction module. In some aspects the nonporous backing layer can comprise a polymeric film. Exemplary polymeric films can include but are not limited to a polyolefin such as polypropylene, polyethylene, polyvinyl chloride, and the like, a polyester such as polyethylene terephthalate, a thermoset material such as an epoxy, a polyamide, a polyether ether ketone, or a fluorinated polymer such as poly(tetrafluoroethylene). Combinations of the foregoing materials are also contemplated. In some aspects the nonporous backing layer can optionally comprise one or more additives, for example a reinforcing filler. Suitable reinforcing fillers are generally known. In a specific aspect, the reinforcing filler can comprise glass fibers.

In some aspects, the nonporous backing layer, the porous active layer, or both can optionally further comprise or be in contact with a reinforcing support layer configured to provide dimensional stability, tensile strength, and resistance to compressive back-pressure within an extraction element. The reinforcing support layer can include a woven, knitted, expanded, perforated, etched, or sintered metallic mesh; an inorganic woven or non-woven fiber fabric; or a hybrid composite thereof. Suitable metallic materials include, but are not limited to, stainless steels such as 304, 316, 316L, 904L, and 2205 duplex stainless steel; nickel-based alloys such as Inconel 600, 625, 718, Hastelloy C-22, C-276, and Alloy 20; titanium and its alloys such as Grades 1-5; nickel, monel, nichrome, tantalum, niobium, copper, aluminum, or combinations and coatings thereof. Suitable inorganic reinforcements can include glass fibers (E-glass, S-glass, C-glass, R-glass), quartz fibers, alumina fibers, silica fibers, silicon carbide fibers, boron nitride fibers, and basalt fibers. In some aspects, the metallic or inorganic reinforcement can be coated, plated, or surface-treated with a polymeric or fluoropolymeric material, such as a poly(tetrafluoroethylene), poly(vinylidene fluoride), ethylene-tetrafluoroethylene, or polyurethane coating, to improve chemical resistance or bonding compatibility. In some aspects, the reinforcing support layer has a thickness of 50 to 500 micrometers and an open area of 20 to 80%, and may be calendered, etched, or otherwise surface-modified to promote adhesion to adjacent layers. When present, the reinforcing support layer can be disposed on a surface of, or embedded within, the nonporous backing layer or the porous active layer, or can be positioned between the nonporous backing layer and the porous active layer. Without wishing to be bound by theory, when present, the reinforcing support layer can provide structural reinforcement to resist hydraulic compression, telescoping, or delamination of the extraction leaf under operating pressure.

In some aspects, the reinforcing support layer can be bonded to the nonporous backing layer, the porous active layer, or both, by any suitable means that ensures mechanical integrity and chemical compatibility under operating conditions. Bonding can be achieved through thermal lamination, adhesive bonding, melt co-calendering, plasma or corona surface activation, or the use of intermediate tie layers. Exemplary tie-layer materials can include thermoplastic adhesives such as polyethylene-vinyl acetate (EVA), ethylene-acrylic acid (EAA) copolymers, polyurethane (TPU), polyethylene, polypropylene, or fluorinated copolymers such as FEP or PFA. In some aspects, silane or titanate coupling agents, including aminosilanes, epoxysilanes, or methacryloxy-silanes, can be applied to metallic or inorganic surfaces to promote adhesion with polymeric layers. In further aspects, the bonding interface can be enhanced by micro-texturing, chemical etching, or deposition of a primer coating to increase surface energy. The reinforcing support layer can be partially or fully embedded within the nonporous backing layer or positioned at the interface between the backing and the active layer, forming a unitary laminate. In some aspects, the laminate can be formed under a pressure and temperature sufficient to achieve cohesive fusion without compromising various features of the of the active layer (e.g., porosity, extraction functionality, etc.). In some aspects, the bonding layer can provide electrical insulation, chemical passivation, or controlled delamination behavior, depending on the intended process application of the extraction module.

The reinforcing support layer, can present, can be configured to maintain structural integrity of the extraction module under applied hydraulic or mechanical pressure. The reinforcing support layer can exhibit a tensile modulus of, for example, at least 30 gigapascals, or at least 70 gigapascals, and in some aspects, greater than 150 gigapascals, thereby providing dimensional stability and resistance to back-pressure deformation. In some aspects, the reinforcing support layer or laminate can withstand compressive stresses of at least 100 kilopascals, or at least 500 kilopascals, without permanent deformation exceeding 5% of its initial thickness. The reinforcing support layer can possess an open-area fraction of 20 to 80%, or 35 to 60%, to balance fluid distribution and structural rigidity. In some aspects, the thickness of the reinforcing support layer or laminate can be 50 to 500 micrometers, and may be calendered, embossed, or perforated to control surface planarity and winding uniformity within a spiral-wound module. The reinforcing layer may further exhibit a compression recovery ratio of at least 90% following exposure to operating pressure cycles, thereby preventing telescoping, delamination, or collapse of the extraction leaf during operation. In some aspects, the reinforcing layer geometry, including mesh pitch, wire diameter, or weave architecture, is selected to maintain uniform load distribution across the laminate and to minimize pressure drop or local deformation under cyclic stress.

Advantageously, the present extraction module can provide a pressure driven system, whereby no additional means to facilitate ion extraction, such as an electric current, are required. Thus, in some aspects, the present extraction module can exclude electrodes, current collectors, and other components typically included to operate a device under an electric current.

In some aspects, it may be desirable to operate the extraction module under an applied electric current or at a preferred voltage. In such a case, the nonporous back layer can optionally further comprise a counter electrode disposed on a surface of the first nonporous backing layer, a surface of the second nonporous backing layer, or both. When present, the counter electrode layer disposed on the nonporous backing layer can comprise, for example, graphite, metal oxides, activated carbon, nickel or an alloy thereof, silver, a conductive polymer, or a combination thereof. In some aspects, the nonporous backing layer can be the counter electrode. The counter electrode can comprise graphite, metal oxides, activated carbon, nickel or an alloy thereof, silver, a conductive polymer, or a combination thereof. The counter electrode, when serving as the nonporous backing layer, is substantially nonporous as described above.

The porous active layer and the nonporous backing layer are separated in the extraction module by a first and second porous spacer layer. When a second porous active layer is present in the leaf, a third porous spacer layer can be included, for example disposed on the second porous active layer on a side opposite the second porous spacer layer. The spacer layers are permeable or semi-permeable to a fluid. Preferably, each porous spacer layer has a porosity that allows a fluid to flow through the spacer layer. For example, the spacer layers can each independently have a porosity of 5 to 95%, for example at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, and/or no more than 90%, no more than 85%, no more than 80%, no more than 75%, no more than 70%, no more than 65%, no more than 60%, no more than 55%, no more than 50%, no more than 45%, no more than 40%, no more than 35%, no more than 30%, no more than 25%, no more than 20%, no more than 15%, no more than 10%, or no more than 5%, as determined as a volume fraction of the spacer. In an aspect, the spacer layers can each independently have a porosity of 10 to 90%, or 10 to 80%, or 15 to 80%, or 20 to 95%, or 20 to 90%, or 20 to 80%, or 30 to 95%, or 30 to 90%, or 30 to 80%, or 40 to 95%, or 40 to 90%, or 40 to 80%, or 50 to 95%, or 50 to 90%, or 50 to 80%.

In some aspects the porous spacer layer can have any suitable geometry effective to provide an open space of 20 to 90 volume percent, or 25 to 85 volume percent, based on the total volume of the spacer layer. For example, in addition to porous structures, the spacer layer can comprise columns, ribbed structures, islands, ladder patterns, diamond patterns, or the like.

Each of the spacer layers can have the same or different compositions. Preferably the first and second spacer layers are prepared from nonconductive materials. Any suitable nonconductive material can be used, including but not limited to cured thermosets (e.g., epoxies), acrylonitrile-butadiene-styrene, polyolefins (e.g., polypropylene, polyethylene), acrylics, fluorinated polymers (e.g., polytetrafluoroethylene, polyvinylidene fluoride, ethylene chlorotrifluoroethylene; a perfluoroalkoxy), polyether ether ketone, polyvinyl chloride, polyquats, and the like or a combination thereof. In a specific aspect, each of the first and second spacer layers can comprise a polyolefin, preferably polyethylene or polypropylene.

The spacer layers can each independently have a thickness of 1 micrometer to 10 millimeters, for example 1 micrometer to 1 millimeter, or 1 to 500 micrometers, or 1 to 250 micrometers, or 1 to 100 micrometers. The pore size of the spacer layer is not particularly restricted, and can range, for example, from 1 micrometer or less up to the millimeter scale. As will be understood by one of skill in the art, the pore size can depend on the total size scale of the module and the size of the individual layers.

The spacer layers can further exhibit certain mechanical properties. For example, the first and second spacer layers can each independently exhibit an elastic compressive modulus of at least 1 megaPascal (MPa), for example at least 10 MPa; a toughness of at least 1 millijoules per square centimeter (mJ/cm²), for example at least 10 mJ/cm²; a compressive strength of at least 0.1 MPa; and an operable trans-film pressure of at least 1 bar, for example 1 to 50 bar. In some aspects, the operable trans-film pressure may be less than 1 bar, for example, 0.1 to less than 1 bar.

The extraction leaf can be connected to the axial chamber by any suitable means, for example as further shown and described herein. In an aspect, the extraction leaf may be directly inserted into a slit or opening in the axial chamber. In some aspects, the slit can be at an angle that is normal to the surface of the axial chamber. In some aspects, the slit can be angled such that the extraction leaf extends from the axial chamber at an angle when attached. The angle can be, for example, greater than 0° to less than 90°. In some aspects a shim, manifold, or other adapter can be used to facilitate connection of the extraction leaf to the axial chamber, wherein one or more protrusions capable of attaching to the extraction leaf are provided. In some aspects, the axial chamber can be formed having the protrusions thereon (i.e., the chamber and manifold are formed from a single piece). In some aspects, the adapters can be an attachment formed from a separate piece. The protrusions can have any suitable shape, and can be, for example, straight, angled, or curved.

The extraction module can further comprise at least one inlet and at least one outlet. The inlet can be capable of providing a fluid (also referred to herein as a “feed stream”) comprising a target species to the extraction module. The outlet can be capable of removing a product stream (also referred to herein as a “target species-depleted fluid) from the extraction module. In some aspects, more than one inlet, more than one outlet, or both can be present. For example, in some aspects, the extraction module can further comprise a second inlet, for example to provide a regenerating fluid to the extraction module, as discussed in further detail below. The inlets and outlets of the extraction module can be provided at any suitable position on the extraction module provided that they remain in fluid communication with the appropriate components of the extraction module. Examples of various inlet positions are further discussed below and shown in the Figures.

In some aspects, the inlet can be in fluid communication with the stack of extraction leaves, such that the feed fluid can be provided directly to the extraction leaves. The outlet can be in fluid communication with an end of the perforated axial chamber. In such an aspect, the fluid can be flowed radially inward toward the axial chamber.

In an aspect, the inlet can be in fluid communication with an end of the perforated axial chamber. The outlet can be in fluid communication with the stack of extraction leaves. In such an aspect, the fluid can be flowed radially outward from the central chamber.

In some aspects, the extraction module can comprise separate inlets for providing a feed fluid to the extraction module and for providing, for example, a stripping or regeneration solution to the extraction module. Including separate inlets capable of providing different fluids to the extraction module can reduce or eliminate cross-contamination between the fluids.

In some aspects, one or more portions of the extraction module can be sealed so as to define or control a desired flow path through the extraction module. Such sealing may be provided along one or more edges or regions of the individual extraction leaves, for example along the outer periphery, leading or trailing edges, or along selected internal boundaries between adjacent layers. The sealing may be achieved, for example, by use of an adhesive, bonding agent, heat sealing, or other suitable joining technique, and may extend continuously or discontinuously as required to direct the feed, permeate, or concentrate streams through predetermined flow channels within the extraction module. By selectively sealing specific areas of the leaves, undesired bypass or intermixing of streams may be prevented, and the hydraulic and separation performance of the element may thereby be optimized.

The extraction module of the present disclosure is particularly well-suited for extraction of a target species from a fluid. For example, the extraction module can be used for extraction of a target species from a fluid mixture, wherein the target species is a metal ion, a metal complex, a metal-containing compound, or a combination thereof. Exemplary target species can include, but are not limited to, alkali metals, alkaline earth metals, transition metals, post-transition metals, lanthanides, actinides, metalloids, precious metals, platinum-group metals, critical metals, rare earth elements, metal anions, metal cations, or metal-containing ionic species, metal complexes, chelated metals, or organometallic compounds, or any combination thereof.

In some aspects, the target species can be present as free ions, hydrolyzed species, ion pairs, polynuclear or clustered ionic species, coordination complexes, chelates, organometallic ions, metallate anions, oxyanions, halometallates, thiometallates, cyanometallates, or combinations thereof, depending on pH, redox potential, ligand environment, ionic strength, and solution composition. In some aspects, the target species can be a cation such as H⁺, NH₄₄⁺, Li⁺, Na⁺, K⁺, Mg²⁺, Ca²⁺, Sr²⁺, Ba²⁺, Al³⁺; transition metals (e.g., Fe²⁺/Fe³⁺, Mn²⁺, Co²⁺/³⁺, Ni²⁺, Cu⁺/²⁺, Zn²⁺, Mo species, W species, V species, Cr species, Ti/Zr/Hf); post-transition metals (e.g. Ga³⁺, In³⁺, Tl⁺/Tl³⁺, Sn²⁺/Sn⁴⁺, Pb²⁺, Bi³⁺); Alkali/alkaline earth metals (Rb⁺, Cs⁺, Be²⁺, Ra²⁺); lanthanides (La³⁺—Lu³⁺, Y³⁺, Sc³⁺); actinides (UO₂²⁺, Th⁴⁺ and related complexes); heavy metals (Pb²⁺, Cd²⁺, Hg²⁺, Bi³⁺); metalloids (e.g., B species, Si species, Ge species, As species, Sb species, Se species, Te species); platinum group metals (Pt, Pd, Rh, Ru, Ir, Os); precious metals (Ag, Au); organometallic complexes; anions/oxyanions including but not limited to F⁻, Cl⁻, Br⁻, I⁻, OH⁻, NO₃⁻, NO₂⁻, SO₄²⁻, SO₃²⁻, HSO₄⁻, CO₃²⁻, HCO₃⁻, PO₄³⁻/HPO₄²⁻, silicate species (e.g., SiO(OH)₃⁻), borate species (e.g., BOH₄⁻), chromate/dichromate (CrO₄²⁻/Cr₂O₇²⁻), permanganate (MnO₄⁻), molybdate (MoO₄²⁻), tungstate (WO₄²⁻), vanadate species (e.g., VO₃⁻/HVO₄²⁻/VO₄³⁻), arsenite/arsenate species, selenite/selenate species, tellurite/tellurate species, CN⁻; metal-cyanide complexes (e.g., [Au(CN)₂]⁻, [Ag(CN)₂]⁻, [Cu(CN)₂]⁻), chloro-and fluoro-metal complexes (e.g., [PtCl₆]²⁻, [PdCl₄]²⁻, [SnCl₆]²⁻, [SbCl₆]⁻, [NbF₇]²⁻, [TaF₇]²⁻), per-/polyfluoroalkyl substances (PFAS) (e.g., PFOA⁻, PFOS⁻), organic acids/bases (e.g., acetate, citrate, lactate, succinate, benzoate, quaternary ammonium salts), heat-stable amine salts, and biomolecule polyelectrolytes (e.g., nucleic acids, proteins, endotoxin).

In some aspects, the extraction module can be used for metallurgical separations and purification, including hydrometallurgy, electrometallurgy, and secondary metallurgy/recycling, for example for recovery and/or purification of one or more target metal species from process fluids, and/or for removal of impurity species from metal-bearing streams. Non-limiting examples include separation, polishing, or impurity removal in leach liquors, pregnant solutions, purified leach solutions, barren solutions/raffinates, strip liquors, electrolytes, bleed streams, recycle streams, wash/rinse waters, and mother liquors, as well as intermediate or auxiliary purification loops associated with such processes. In some aspects, the target species comprises at least one of lithium, one or multiple rare earth element(s), uranium, gold, silver, gallium, molybdenum, tungsten, vanadium, chromium, mercury, platinum group metals (e.g., platinum, palladium, ruthenium, rhodium, rhenium, osmium, iridium, etc.), or a combination thereof. In an aspect, the extraction module can be suitable for water treatment, for example to remove perfluoroalkyl species (PFAS) or organic pollutants, production of ultrapure water, polishing, softening, or nutrient recovery (e.g., recovery of nitrate, phosphate, or fluoride). The extraction module can be useful in waste management applications, for example treatment of industrial effluents or landfill leachates. In some aspects, the fluid can be a gas such as air, and the extraction module may be useful for air purification (e.g., carbon capture, pressure swing adsorption, or sulfur removal).

The tunability of the porous active layer for the present extraction module enables application of the present disclosure to various processes including water treatment (e.g., demineralization, municipal and industrial softening, nutrient control, heavy metal abatement, PFAS removal, boron and silica polishing, chlor-alkali brine purification, acid mine drainage treatment, brine conditioning); critical mineral recovery (e.g., lithium recovery, lanthanide separation, nickel-cobalt-manganese separation, vanadium recovery, uranium and actinide capture, precious metal recovery, gallium recovery, battery recycling leachate conditions); chemical processing (e.g., heterogeneous catalysis, neutralization, organic acid production, amino acid and peptide purification, biodiesel polishing, sugar deashing and decolorization, solvent and monomer purification); and environmental remediation (e.g., landfill leachate treatment, groundwater remediation, industrial spill response, radiological waster polishing).

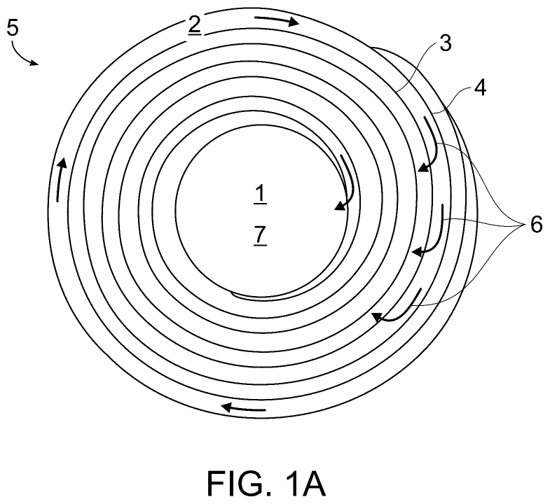

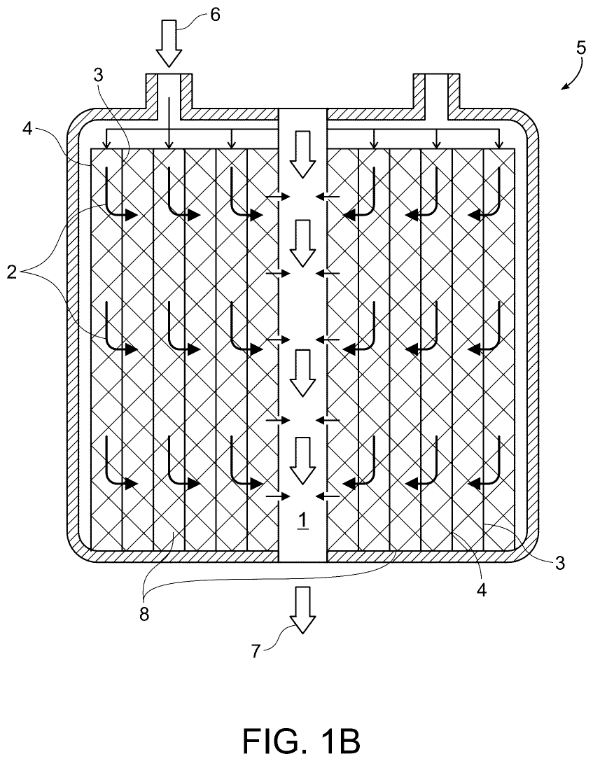

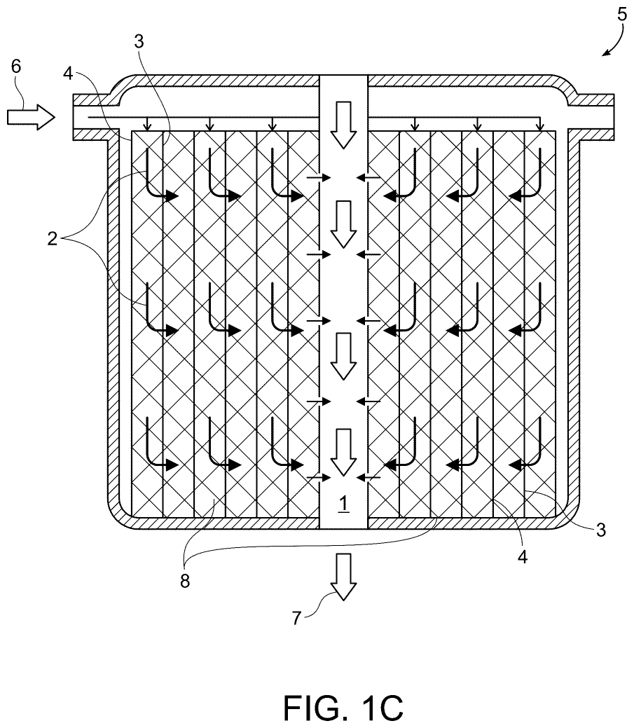

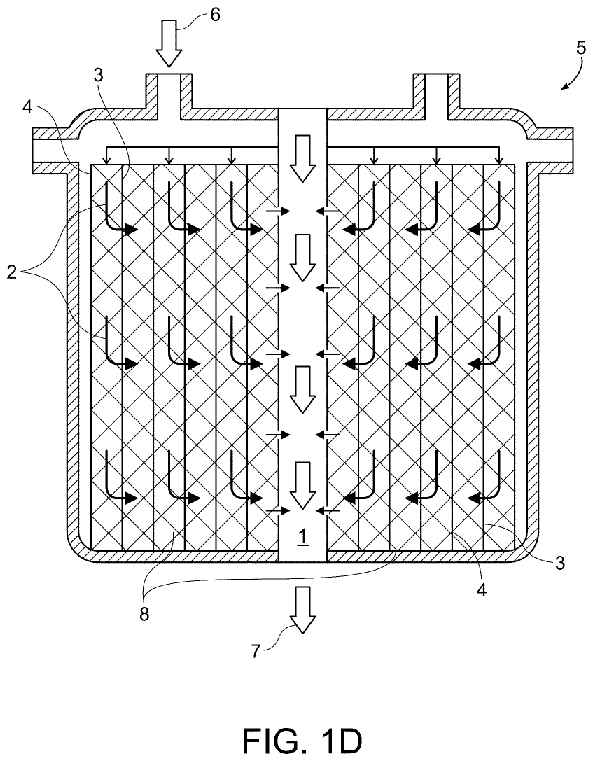

Exemplary extraction modules according to various aspects of the present disclosure can be as shown and described in the Figures. Referring to the Figures, FIG. 1A shows an exemplary spiral wound geometry for an extraction module according to an aspect of the present disclosure. The extraction module 5 includes a central axial flow chamber 1. Extraction leaves including a porous active layer 3 and a non-permeable backing layer 4 are wound in a radially curved fashion (e.g., in a spiral) around the central axis 1. A fluid feed stream 6 is provided to the extraction leaves and flows inward radially toward the central axis (indicated by reference number 2), with the arrows indicating the direction of flow. The target species is at least partially incorporated by the extraction leaves, providing a product stream 7 which is depleted of the target species.

FIG. 1B shows a cross-sectional view of the spiral wound module of FIG. 1A, showing fluid flow patterns in a standard operation with an inward radial flow, according to an aspect of the present disclosure. As shown in FIG. 1B, the extraction module 5 includes a central axial flow chamber 1. Extraction leaves including a porous active layer 3, a non-permeable backing layer 4, and channel spacer layers 8 are wound in a spiral around the central axis 1. A fluid feed stream 6 is provided through an inlet to the extraction leaves and flows inward radially toward the central axis (indicated by reference number 2), with the arrows indicating the direction of flow. The target species is at least partially incorporated by the extraction leaves, providing a product stream 7 which is depleted in the target species, and is removed from the module 5 by an outlet at an end of the axial flow chamber 1.

The fluid feed stream can be provided to the extraction leaves of the extraction module through ports which can have varying positions on the extraction module. For example, FIG. 1B illustrates inlet ports positioned at the top face of the extraction module. FIG. 1C illustrates inlet ports positioned on the sides of the extraction module. FIG. 1D illustrates the use of a combination of ports positioned at the top and side of the extraction module. Other variations, while not shown, are also contemplated, provided that the ports are positioned such that the fluid feed stream is provided to the extraction leaves of the extraction module.

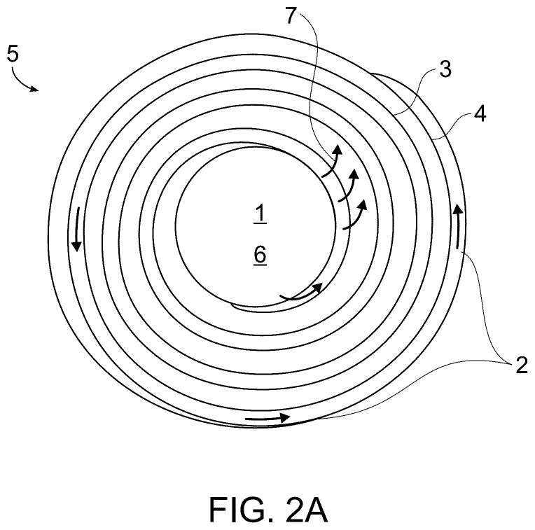

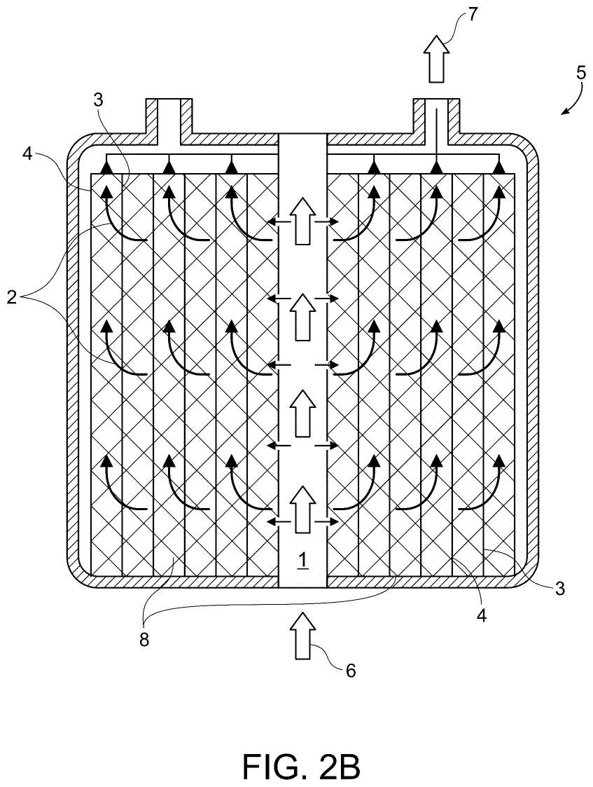

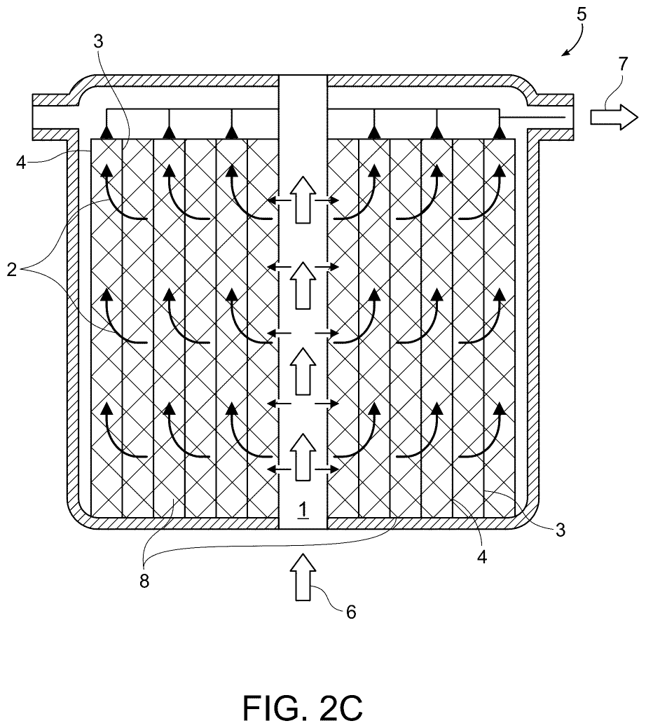

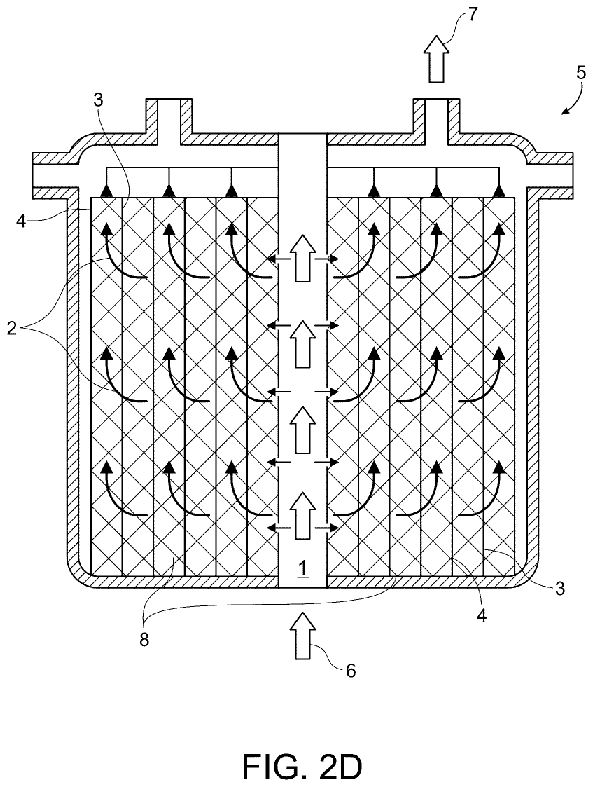

FIG. 2A shows a spiral wound geometry for an extraction module according to an aspect of the present disclosure. The extraction module 5 includes a central axial flow chamber 1. Extraction leaves including a porous active layer 3 and a non-permeable backing layer 4 are wound in a spiral around the central axis 1. A fluid feed stream 6 is provided to the axial chamber 1 and flows outward radially toward through the extraction leaves toward the periphery of the module (flow indicated by reference number 2), with the arrows indicating the direction of flow. The target species is at least partially incorporated by the extraction leaves, providing a product stream 7 which is depleted in the target species.

FIG. 2B shows a cross sectional view of the spiral wound module of FIG. 2A, showing fluid flow patterns in a standard operation with an outward radial flow, according to an aspect of the present disclosure. As shown in FIG. 2B, the extraction module 5 includes a central axial flow chamber 1. Extraction leaves including a porous active layer 3, a non-permeable backing layer 4, and channel spacer layers 8 are wound in a spiral around the central axis 1. A fluid feed stream 6 is provided through an inlet to the central axial chamber and flows outward radially through the extraction leaves (indicated by reference number 2), with the arrows indicating the direction of flow. The target species is at least partially incorporated by the extraction leaves, providing a product stream 7 which is depleted in the target species, and is removed from the module 5 by an outlet in fluid communication with the extraction leaves of the module.

The product stream can be removed from the module through one or more outlets which can have varying positions on the extraction module. For example, FIG. 2B illustrates outlet ports positioned at the top face of the extraction module. FIG. 2C illustrates outlet ports positioned on the sides of the extraction module. FIG. 2D illustrates the use of a combination of outlets positioned at the top and side of the extraction module. Other variations, while not shown, are also contemplated, provided that the outlets are positioned such that the outlets are in fluid communication with the extraction leaves to facilitate removal of the product stream.

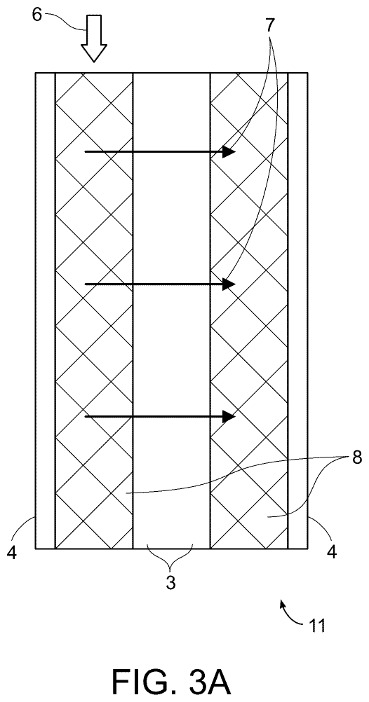

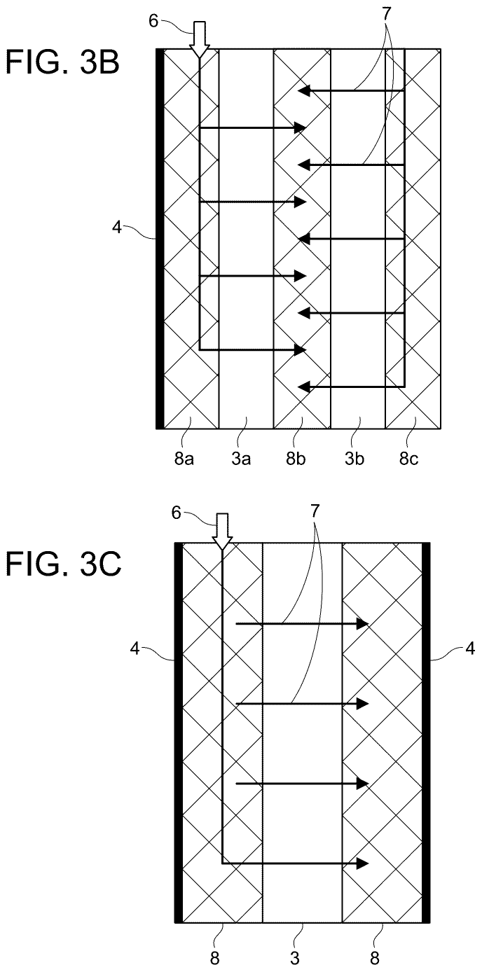

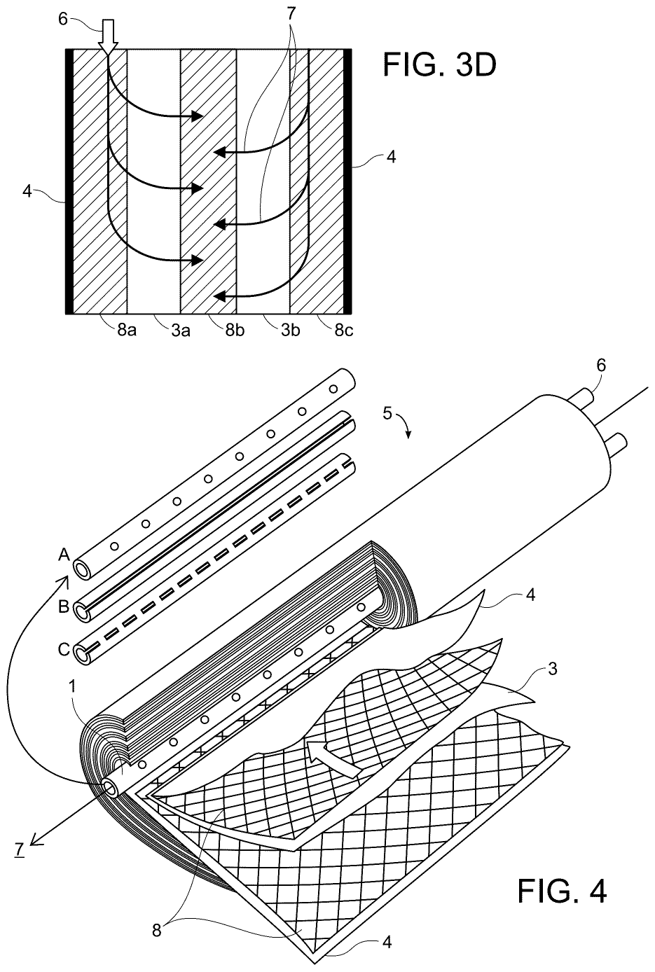

FIG. 3A shows a cross-sectional view of an extraction leaf. The extraction leaf 11 includes a non-permeable backing layer 4, a porous active layer 3, and spacer layers 8 between the non-permeable backing layer 4 and the porous active layer 3, wherein the individual layers are arranged as shown. A feed fluid 6 enters the extraction leaf and flows through the leaf, wherein at least a portion of a target species in the feed fluid is extracted from the fluid to provide a target species-depleted fluid 7.

FIG. 3B shows a cross-sectional view of an extraction leaf according to an aspect of the present disclosure. The extraction leaf 11 includes a non-permeable backing layer 4, a first porous active layer 3A, a second porous active layer 3B, a first spacer layer 8A between the non-permeable backing layer 4 and the first porous active layer 3, a second spacer layer 8B between the first and second porous active layers, and a third spacer layer 8C on the second porous active layer 3B a side opposite the second spacer layer 8B. A feed fluid 6 enters the extraction leaf and flows through the leaf, wherein at least a portion of a target species in the feed fluid is extracted from the fluid to provide a target species-depleted fluid 7.

FIG. 3C shows a cross-sectional view of an extraction leaf. The extraction leaf 11 includes two non-permeable backing layers 4, a porous active layer 3, and spacer layers 8 between each non-permeable backing layer 4 and the porous active layer 3, wherein the individual layers are arranged as shown. A feed fluid 6 enters the extraction leaf and flows through the leaf, wherein at least a portion of a target species in the feed fluid is extracted from the fluid to provide a target species-depleted fluid 7.

FIG. 3D shows a cross-sectional view of an extraction leaf according to an aspect of the present disclosure. The extraction leaf 11 includes two non-permeable backing layers 4, a first porous active layer 3A, a second porous active layer 3B, a first spacer layer 8A between the non-permeable backing layer 4 and the first porous active layer 3, a second spacer layer 8B between the first and second porous active layers, a third spacer layer 8C on the second porous active layer 3B a side opposite the second spacer layer 8B, and a second non-permeable backing layer 4 on the third spacer layer 8C on a side opposite the second porous active layer. A feed fluid 6 enters the extraction leaf and flows through the leaf, wherein at least a portion of a target species in the feed fluid is extracted from the fluid to provide a target species-depleted fluid 7.

FIG. 4 shows an expanded and partially cut away view of an extraction nodule according to an aspect of the present disclosure. The extraction module 5 includes a central axial flow chamber 1. Extraction leaves including a porous active layer 3, a non-permeable backing layer 4, and spacer layers 8 are wound in a spiral around the central axis 1. A fluid feed stream 6 is provided to an inlet in fluid communication with the extraction leaves and flows inward radially toward through the extraction leaves to the central axial chamber. The target species is at least partially adsorbed by the extraction leaves, providing a product stream 7 which is depleted in the target species and can be removed via an outlet at an end of the axial chamber. The axial chamber includes one or more openings which can have any suitable shapes including, but not limited to, circular openings (A), an elongated thin slit (B), or a linear interrupted thin slit (C).

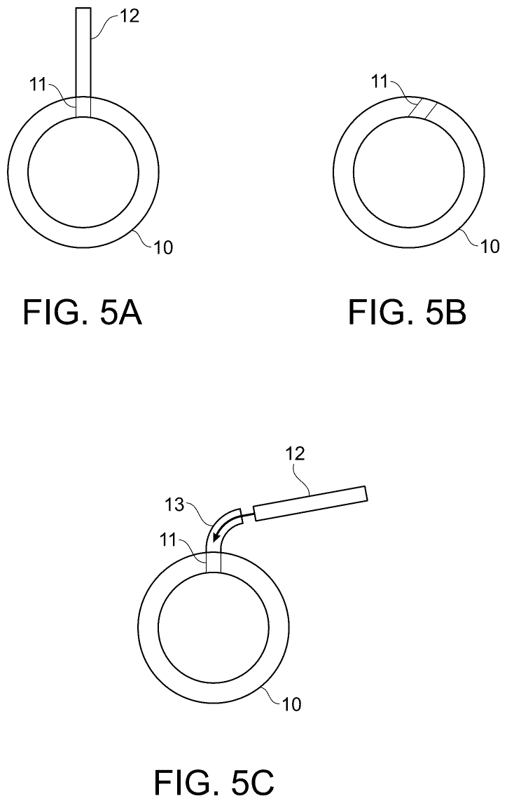

FIGS. 5A, 5B, and 5C illustrate exemplary connections between an extraction leaf and the central axial chamber. As shown in FIG. 5A, an extraction leaf may be directly inserted into a slit in the central axial chamber. While FIG. 5A illustrates the connection of a single extraction leaf to the axial chamber, it will be appreciated that a plurality of extraction leaves can be attached around the periphery of the axial chamber by provided a desired number of slits into which the extraction leaves can be directly inserted.

Alternatively, as shown in FIG. 5B the slit into which the extraction leaf is to be inserted can be provided at an angle relative to the circumferential plane. Preferably the angle can be greater than 0° C. and less than 90°. While FIG. 5B illustrates the connection of a single extraction leaf to the axial chamber, it will be appreciated that a plurality of extraction leaves can be attached around the periphery of the axial chamber by provided a desired number of slits into which the extraction leaves can be directly inserted.

In another aspect, as shown in FIG. 5C, one or more protrusions from the outer surface of the axial chamber can be used as the connection point to the extraction leaf. The protrusion may also be referred to herein as a manifold, a shim, or an adapter. The axial chamber and adapter may be crafted from a single solid body or the adapter can be an attachment that is inserted and attached via a slit or opening on the axial chamber. The extraction leaf can be inserted into the opening at the opposite end of the adapter. The adapter may have any suitable shape and can have, for example, a straight angle or be curved.

An apparatus for extraction of a target species represents another aspect of the present disclosure. The apparatus can comprise any suitable number of extraction modules, and the extraction modules can generally be arranged in any suitable fashion, for example in parallel or in series. In some aspects, the apparatus can comprise two or more extraction modules, preferably arranged in series. When two or more extraction modules are present, each extraction module can selectively extract a particular target species from the feed fluid. For example, the apparatus can comprise a first extraction module for adsorption of a first target species from a fluid; and a second extraction module for adsorption of a second target species from the fluid; wherein the first target species and the second target species are different.

A method for extraction of a target species represents another aspect of the present disclosure. The method comprises providing a feed fluid comprising a target species to the extraction module as described herein. The extraction module is operated under conditions effective to facilitate extraction of at least a portion of the target species from the feed fluid, for example by adsorption, chelation, or ion exchange to the porous active layer of the extraction leaf.

For example, during a typical cycle of the method, the feed fluid containing the target species can be introduced into the extraction module. As the feed fluid flows through the extraction module, the target species can be selectively retained within the active layer (e.g., via ion-exchange, chelation, adsorption, etc.), while a product stream exits the module outlet. The module can optionally be rinsed with a suitable rinse fluid to remove residual feed material. Thereafter, an elution step may be performed in which an elution fluid is passed through the module to release and recover the retained target species. A regeneration step may then be conducted to restore the active layer's capacity for capturing the target species in subsequent cycles. Optionally, a final rinse may be applied to remove any residual elution or regeneration fluids prior to introducing a fresh feed fluid to initiate a new extraction cycle. The method steps are further discussed in detail below.

The feed fluid can be, for example, an aqueous fluid comprising the target species. The feed fluid can generally be any fluid where it may be desirable to extract an ionic target species, for example including, but not limited to, municipal and industrial water streams for softening, dealkalization, and polishing; wastewater, brines, and produced waters for nutrient control, heavy-metal abatement, PFAS removal, and selective ion recovery; chlor-alkali and geothermal brines; leachates and process liquors in metallurgy and critical mineral recovery (e.g., lithium, rare earths, nickel, cobalt, vanadium, uranium, precious metals, gallium, germanium, scandium, niobium/tantalum, tellurium, gold) including but not limited to pregnant leach solutions, purified leach solutions, raffinates, recycled streams, bleeds, electrolytes, rinse waters, process water recycle, thickener underflow/overflow, CCD wash solutions, eluates, regenerant solutions, wet scrubber liquors, acid plant blowdown, and mother liquors; mine and mine-impacted waters including but not limited to mine dewatering waters, pit lake water, contact water, acidic and neutral mine drainage, tailings pond water, and heap pad drainage; battery recycling solutions; e-waste recycling solutions, chemical process streams for acid/base neutralization, catalyst scavenging, and purification of organic acids, amino acids, sugars, solvents, and monomers; food and beverage fluids such as dairy, wine, juice, and flavor/fragrance intermediates; household point-of-use cartridges; high-purity utility waters for power generation and microelectronics (e.g., condensate polishing, semiconductor UPW, CMP slurry reclaim); and environmental remediation matrices including landfill leachate, groundwater, industrial spill response, and radiological waste streams. Exemplary feed fluids can include, but are not limited to, a salt-lake brine, a subterranean brine, a geothermal brine, seawater, a leach liquor from hard-rock mining, a leachate from lithium-ion battery recycling, or other potential sources of target species (e.g., lithium).

In some aspects, the feed fluid can be a non-aqueous solution. For example, when the target species is lithium and the feed fluid is a lithium-ion battery electrolyte including an organic solvent, such as ethylene carbonate, ethyl methyl carbonate, dimethyl carbonate, and the like. The lithium-ion battery electrolyte can be obtained, for example, from aged lithium-ion batteries and the lithium extraction can be performed during a battery recycling process.

In some aspects, the target species can be present in the feed fluid in an amount of at least 0.00001 mole percent (mol %), 0.0001 mol %, 0.001 mol %, 0.01 mol %, at least 0.02 mol %, at least 0.03 mol %, at least 0.05 mol %, at least 0.1 mol %, at least 0.2 mol %, at least 0.3 mol %, at least 0.5 mol %, at least 1 mol %, at least 2 mol %, at least 3 mol %, at least 5 mol %, or at least 10 mol % of the target species. Other concentrations are also possible. In some cases, the concentration of the target species may not be known.

The feed stream comprising the target species can be provided to the extraction module using a continuous flow or a pulsed flow. As discussed above, the feed stream can be provided to the extraction leaves and flow radially inward, or the feed stream can be provided to the central axial chamber and flow radially outward. In an aspect, the fluid can be provided to one or more of the extraction leaves of the module and the fluid flows radially inward toward the axial chamber, and a target species depleted-fluid is removed from the module at an outlet of the axial chamber. In an aspect, the fluid can be provided to an inlet of the axial chamber of the module and the fluid flows radially outward toward a periphery of the module, and a target species depleted-fluid is removed from the module at an outlet in fluid communication with the stack of extraction leaves.

The method can therefore further comprise removing a product stream from the extraction module. The product stream has a concentration of the target species that is less than a concentration of the target species in the feed stream supplied to the extraction module. In some aspects, the product stream can have a target species concentration that is 90% of the concentration of the target species in the feed stream, for example 85%, or 80%, or 75%, or 65%, or 60%, or 50%, or 45%, or 40%, or 30%, or 25%, or 15%, or 10%, or 5%, or 1%, or 0.01% of the concentration of the target species in the feed stream.

In an aspect, the method can optionally further comprise removing residual feed fluid from the extraction module. Removing residual feed fluid can comprise introducing a rinse solution to the extraction module. The rinse solution can be flowed through the extraction module prior to regenerating the extraction module, discussed further herein. Without wishing to be bound by theory, it is believed that incorporating a rinse solution step can prevent undesirable mixing of the feed fluid and the product fluid. The rinse solution is an inert fluid, and can optionally be used in combination with electrical operating conditions to preferentially elute undesired impurities that may be incorporated with the target species. As used herein, the term “inert fluid” with respect to the rinse solution refers to a fluid having a composition that has no chemical reactivity towards any component of the apparatus (e.g., ligands present on the extraction media, ions bound or adsorbed to the extraction media, etc.).

In an advantageous feature, the captured target species can be released from the extraction module, and the extraction module can optionally be regenerated. For example, following extraction of the target species into the extraction leaves, the method can further comprise releasing captured target species from the extraction leaves by providing a stripping solution to the extraction module. The stripping solution is effective to release the adsorbed, chelated, or otherwise bound target species from the porous active layers of the extraction leaves. The release can therefore provide a second product stream that is rich in the target species. The target species can optionally be collected and reused for further applications. In some aspects, it can be advantageous to employ an electric current in the regeneration process as well.

In some aspects, following release and removal of captured target species from the extraction module, it can be desirable to regenerate the extraction module, for example for use in subsequent processes. As used herein, “regeneration of the extraction module” refers to treating the extraction module under conditions effective to restore the adsorption, chelation, or ion-exchange capacity of the extraction leaves, if needed. For example, a regenerative fluid can be provided to the extraction module which is capable of regenerating the adsorption, chelation, or ion-exchange capacity of the active layer of the extraction leaves. In an aspect wherein the extraction leaves include an active layer having ion-exchange capacity, the functional groups of the active layer can be regenerated by an acidic or basic regenerative fluid, selected depending on the identity of the ion-exchange functional group.

The composition of the stripping solution can depend on the identity of the target species to be released or removed from the extraction layer. In some aspects, the stripping solution can be pure water (e.g., fresh water, naturally occurring water, desalinated water, distilled water, deionized water, or the like), or a solution that has a low concentration (e.g., no more than 0.01 mol %) of the target species. In some aspects, use of an acidic or basic stripping solution can be preferred. Exemplary basic stripping solutions can comprise aqueous solutions of sodium hydroxide, sodium bicarbonate, sodium hypochlorite, or the like. In some aspects, the basic solution can be effective to remove inorganic foulants (e.g., silica) or corrosion products. The basic solution can have a pH of at least 8, or at least 9, or at least 10, or at least 11, or more. Exemplary acidic stripping solutions can comprise aqueous solutions comprising hydrochloric acid, citric acid, formic acid, acetic acid, or the like. In some aspects, the acidic solution can be effective to dissolve or remove limescale, hard water scale, or other inorganic fouling or corrosion products. The acidic stripping solution can have a pH of less than 6, or less than 5, or less than 4, or less than 3, or less than 2.

The stripping solutions can optionally further comprise various additives, for example a biocide to treat fouling, corrosion inhibitors, antioxidants, oxygen scavengers, pH buffers, coagulants, flocculants, abrasive particles, anti-freeze additive, coolant, and the like, or a combination thereof.

The flow rate of the stripping fluid can optionally be selected to aid in regenerating the extraction module. For example, the stripping solution can be provided to the module at relatively high flow rates or at relatively high pressures. This can cause the introduction of various shear forces to be applied to the extraction leaves, and may be helpful to remove fluids or other products from the module, such as colloidal particles, sediment, chemical deposits, microorganisms, electrochemical deposits, and the like.

In an aspect, the flow rate of the stripping fluid can be pulsed to aid in regenerating the extraction module. For example, the stripping solution can be provided to the extraction module at a flow rate, and allowed to remain in contact with the porous active layer for a predetermined residence time without any fluid velocity. Without wishing to be bound by theory, this pulsed flow can increase the extraction of the target species from the active layer, aiding in recovery of the target species (e.g., increased concentration of the target species of a product fluid stream, and reduced total volume of stripping fluid used relative to a continuous flow embodiment).

The stripping solution can be flowed radially inward or outward. In some aspects, the stripping solution can be flowed in the same direction that the feed fluid was flowed through the extraction module during standard operation. In some aspects, the stripping solution can be flowed in the opposite direction relative to the direction of the feed fluid during standard operation. It can be advantageous to flow the stripping solution in the opposite direction to aid in removing any particulates or prevent fouling in the extraction leaves of the extraction module. In some aspects, the stripping solution can be provided to the extraction module via the same inlet as for the feed fluid. In some aspects, the stripping solution can be provided to the extraction module via a separate inlet.

In some aspects, the stripping solution comprising the released target species can be directly used for further application, without the need for subsequent processing, purification, crystallization or the like. In some aspects, subsequent processing steps such as reverse osmosis, evaporation, precipitation, or the like may be required to concentrate the target species.

This disclosure further encompasses the following aspects.
Aspect 1: An extraction module comprising: an axial chamber having one or more openings, the axial chamber positioned about a central axis; and an extraction leaf, the extraction leaf comprising: a first porous active layer comprising a fibrous mat; a first nonporous backing layer; a first porous spacer layer disposed between the first porous active layer and the first nonporous backing layer; a second porous spacer layer disposed on the first porous active layer on a side opposite the first porous spacer layer; optionally, a second porous active layer comprising a fibrous mat disposed on the second porous spacer layer on a side opposite the first porous active layer; optionally, a third porous spacer layer disposed on the second porous active layer on a side opposite the second porous spacer layer; and optionally, a second nonporous backing layer disposed on the second porous spacer layer on a side opposite the first porous active layer or, when present, on the third porous spacer layer on a side opposite the second porous active layer; wherein the extraction leaf extends outward from the central axis along a radially curved trajectory.
Aspect 2: The extraction module of aspect 1, wherein the radially curved trajectory comprises a constant-pitch spiral having uniform thickness across all radial and polar dimensions.
Aspect 3: The extraction module of aspect 1 or aspect 2, wherein the extraction leaf extends outward from the central axis in a spiral, and the spiral is a linear Archimedean spiral.
Aspect 4: The extraction module of aspect 3, wherein the spiral has constant inter-turn spacing.
Aspect 5: The extraction module of aspect 4, wherein the spiral is a linear Archimedean spiral having constant pitch, a modified exponential spiral, or a spiral geometry configured to maintain uniform thickness across all radial and polar dimensions.
Aspect 6: The extraction module of any of aspects 1 to 5, wherein the axial chamber has a channel width of 1 mm to 100 cm.
Aspect 7: The extraction module of any of aspects 1 to 6, wherein the axial chamber has a plurality of openings arranged circumferentially, longitudinally, or both along the axial chamber, optionally wherein each opening has an average width of 0.1 mm to 10 cm and an average length of 1 mm to 10 cm, optionally wherein the opening is a circular opening.
Aspect 8: The extraction module of any of aspects 1 to 7, wherein the extraction module comprises 1 to 40 extraction leaves, preferably 3 to 6 extraction leaves.
Aspect 9: The extraction module of any of aspects 1 to 8, wherein the extraction leaf is an adsorption leaf, a chelation leaf, or an ion-exchange leaf.
Aspect 10: The extraction module of any of aspects 1 to 9, wherein the extraction leaf is an ion-exchange leaf, wherein the first porous active layer comprises a functionalized fibrous mat comprising a polymer, wherein at least a portion of the polymer repeating units comprise an ion-exchange functional group.
Aspect 11: The extraction module of any of aspects 1 to 10, wherein the first porous active layer, the second porous active layer, or both comprise: the fibrous mat; optionally, a binder; and optionally, a conductive additive.
Aspect 12: The extraction module of aspect 11, wherein the binder is a polymeric binder, preferably comprising polyvinylidene fluoride, polypyrrole, polyaniline, polyethylene oxide, cellulose, a styrene-butadiene rubber, a polyacrylonitrile, a polyamide, polyvinyl alcohol, polytetrafluoroethylene, polystyrene, polymethyl methacrylate, a polyimide, polycaprolactone, polylactic acid, or a combination thereof.
Aspect 13: The extraction module of any of aspects 11 or 12, wherein the binder comprises a conductive polymer, preferably comprising polypyrrole, polyaniline, or a combination thereof.
Aspect 14: The extraction module of any of aspects 11 to 13, wherein the conductive additive is present and comprises carbon, preferably graphitic carbon, carbon black, graphene oxide, reduced graphene oxide, carbon nanotubes, Vulcan carbon, petroleum coke, or a combination thereof.
Aspect 15: The extraction module of any of aspects 10 to 14, wherein the first porous active layer, the second porous active layer, or both further comprise a crosslinker, preferably a crosslinker comprising ethylenic unsaturation.
Aspect 16: The extraction module of any of aspects 10 to 15, wherein the first porous active layer, the second porous active layer, or both further comprise a coating disposed on at least a portion of a surface of the first porous active layer, the second porous active layer, or both, preferably wherein the coating is hydrophilic.
Aspect 17: The extraction module of any of aspects 10 to 16, wherein the first porous active layer, the second porous active layer, or both further comprise a support material comprising a mesh, cloth, wherein the support material is disposed on a surface of or embedded in the first porous active layer, the second porous active layer, or both.
Aspect 18: The extraction module of any of aspects 1 to 17, wherein the first and second nonporous backing layers each independently comprise a nonpermeable material, preferably a polymeric film, more preferably a polymeric film comprising a thermoplastic polymer, a thermoset polymer, or a composite material.
Aspect 19: The extraction module of any of aspects 1 to 18, wherein the first and second nonporous backing layers each independently comprise a polymeric film, preferably wherein the polymeric film comprises polypropylene, polyethylene, polyvinyl chloride, polyethylene terephthalate, an epoxy, a polyamide, a polyether ether ketone, or a poly(tetrafluoroethylene), optionally further comprising a reinforcing filler, preferably glass fibers.
Aspect 20: The extraction module of any of aspects 1 to 19, wherein the first, the second, and the third porous spacer layers are the same or different.
Aspect 21: The extraction module of any of aspects 1 to 20, wherein the first, the second, and the third porous spacer layers each independently comprise a nonconductive material and each independently has a porosity of 5 to 95%.
Aspect 22: The extraction module of any of aspects 1 to 21, wherein the extraction module is for extraction of a target species from a fluid, wherein the target species a metal ion, a metal complex, a metal-containing compound, or a combination thereof.
Aspect 23: The extraction module of any of aspects 1 to 22, further comprising an inlet capable of providing the fluid comprising the target species to the module, and an outlet capable of removing a target species-depleted fluid from the module.
Aspect 24: The extraction module of aspect 23, wherein the inlet is in fluid communication with a stack of extraction leaves; and the outlet is in fluid communication with the axial chamber.
Aspect 25: The extraction module of aspect 23, wherein the inlet is in fluid communication with the axial chamber; and the outlet is in fluid communication with a stack of extraction leaves.
Aspect 26: The extraction module of any of aspects 23 to 25, comprising a first inlet capable of providing a feed stream to the extraction module and a second inlet capable of providing a stripping solution capable of regenerating the extraction module.
Aspect 27: The extraction module of any of claims 23 to 26, wherein the extraction leaf is connected to the central axial chamber by direct insertion into an opening extending through a wall of the axial chamber, wherein the opening is oriented perpendicular to the chamber wall, or the opening is oriented at an angle that is greater than 0° and less than 90° relative to the chamber wall.
Aspect 28: The extraction module of any of aspects 23 to 26, wherein the extraction leaf is connected to the central axial chamber by an adapter.
Aspect 29: An apparatus for extraction of a target species comprising the extraction module of any of aspects 1 to 28.
Aspect 30: The apparatus of aspect 29, comprising two or more of the extraction modules, preferably arranged in series.
Aspect 31: The apparatus of claim 30, comprising a first extraction module for extraction of a first target species from a fluid; and a second extraction module for extraction of a second target species from the fluid; wherein the first target species and the second target species are different.
Aspect 32: A method for adsorption of a target species, the method comprising: providing a fluid comprising a target species to the extraction module of any of aspects 1 to 28 or the apparatus of any of aspects 29 to 31; wherein at least a portion of the target species is incorporated to the porous active layer.
Aspect 33: The method of aspect 32, further comprising removing a product stream from the extraction module or the apparatus, wherein the product stream has a concentration of the target species that is less than a concentration of the target species in a feed stream.
Aspect 34: The method of any of aspects 32 to 33, wherein providing the fluid is using a continuous flow.
Aspect 35: The method of any of aspects 32 to 34, wherein providing the fluid is using a pulsed flow.
Aspect 36: The method of any of aspects 32 to 35, wherein the fluid is provided to one or more of the extraction leaves of the extraction module and the fluid flows radially inward toward the axial chamber, and a target species depleted-fluid is removed from the module at an outlet of the axial chamber.
Aspect 37: The method of any of aspects 32 to 36 wherein the fluid is provided to an inlet of the axial chamber of the extraction module and the fluid flows radially outward toward a periphery of the module, and a target species depleted-fluid is removed from the module at an outlet in fluid communication with the extraction leaves.
Aspect 38: The method of any of aspects 32 to 37, further comprising releasing captured target species from the extraction leaf and regenerating the extraction module.
Aspect 39: The method of aspect 38, wherein releasing captured target species from the extraction leaf comprises providing a stripping solution to the extraction module, wherein the stripping solution is effective to release the incorporated target species from the porous active layer to provide a second product stream comprising the target species.
Aspect 40: The method of aspect 38 or 39, wherein regenerating the extraction module further comprises applying a current to the extraction module.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. An extraction module comprising:
an axial chamber having one or more openings, the axial chamber positioned about a central axis; and
an extraction leaf, the extraction leaf comprising
a first porous active layer comprising a fibrous mat;
a first nonporous backing layer;
a first porous spacer layer disposed between the first porous active layer and the first nonporous backing layer;
a second porous spacer layer disposed on the first porous active layer on a side opposite the first porous spacer layer;
optionally, a second porous active layer comprising a fibrous mat disposed on the second porous spacer layer on a side opposite the first porous active layer;
optionally, a third porous spacer layer disposed on the second porous active layer on a side opposite the second porous spacer layer; and
optionally, a second nonporous backing layer disposed on the second porous spacer layer on a side opposite the first porous active layer or, when present, on the third porous spacer layer on a side opposite the second porous active layer;
wherein the extraction leaf extends outward from the central axis along a radially curved trajectory.

2. The extraction module of claim 1, wherein the radially curved trajectory comprises a constant-pitch spiral having uniform thickness across all radial and polar dimensions.

3. The extraction module of claim 1, wherein the extraction leaf extends outward from the central axis in a spiral, and the spiral is a linear Archimedean spiral.

4. The extraction module of claim 3, wherein the spiral has constant inter-turn spacing.

5. The extraction module of claim 4, wherein the spiral is a linear Archimedean spiral having constant pitch, a modified exponential spiral, or a spiral geometry configured to maintain uniform thickness across all radial and polar dimensions.

6. The extraction module of claim 1, wherein the axial chamber has a channel width of 1 mm to 100 cm.

7. The extraction module of claim 1, wherein the axial chamber has a plurality of openings arranged circumferentially, longitudinally, or both along the axial chamber, optionally wherein each opening has an average width of 0.1 mm to 10 cm and an average length of 1 mm to 10 cm, optionally wherein the opening is a circular opening.

8. The extraction module of claim 1, wherein the extraction module comprises 1 to 40 extraction leaves, preferably 3 to 6 extraction leaves.

9. The extraction module of claim 1, wherein the extraction leaf is an adsorption leaf, a chelation leaf, or an ion-exchange leaf.

10. The extraction module of claim 1, wherein the extraction leaf is an ion-exchange leaf, wherein the first porous active layer comprises a functionalized fibrous mat comprising a polymer, wherein at least a portion of the polymer repeating units comprise an ion-exchange functional group.

11. The extraction module of claim 1, wherein the first porous active layer, the second porous active layer, or both comprise:
the fibrous mat;
optionally, a binder; and
optionally, a conductive additive.

12. The extraction module of claim 11, wherein the binder is a polymeric binder, preferably comprising polyvinylidene fluoride, polypyrrole, polyaniline, polyethylene oxide, cellulose, a styrene-butadiene rubber, a polyacrylonitrile, a polyamide, polyvinyl alcohol, polytetrafluoroethylene, polystyrene, polymethyl methacrylate, a polyimide, polycaprolactone, polylactic acid, or a combination thereof.

13. The extraction module of claim 11, wherein the binder comprises a conductive polymer, preferably comprising polypyrrole, polyaniline, or a combination thereof.

14. The extraction module of claim 11, wherein the conductive additive is present and comprises carbon, preferably graphitic carbon, carbon black, graphene oxide, reduced graphene oxide, carbon nanotubes, Vulcan carbon, petroleum coke, or a combination thereof.

15. The extraction module of claim 10, wherein the first porous active layer, the second porous active layer, or both further comprise a crosslinker.

16. The extraction module of claim 10, wherein the first porous active layer, the second porous active layer, or both further comprise a coating disposed on at least a portion of a surface of the first porous active layer, the second porous active layer, or both.

17. The extraction module of claim 10, wherein the first porous active layer, the second porous active layer, or both further comprise a support material comprising a mesh, cloth, wherein the support material is disposed on a surface of or embedded in the first porous active layer, the second porous active layer, or both.

18. The extraction module of claim 1, wherein the first and second nonporous backing layers each independently comprise a nonpermeable material.

19. The extraction module of claim 1, wherein the first and second nonporous backing layers each independently comprise a polymeric film, preferably wherein the polymeric film comprises polypropylene, polyethylene, polyvinyl chloride, polyethylene terephthalate, an epoxy, a polyamide, a polyether ether ketone, or a poly(tetrafluoroethylene), optionally further comprising a reinforcing filler.

20. The extraction module of claim 1, wherein the first, the second, and the third porous spacer layers are the same or different.

21. The extraction module of claim 1, wherein the first, the second, and the third porous spacer layers each independently comprise a nonconductive material and each independently has a porosity of 5 to 95%, based on a total volume of each spacer layer.

22. The extraction module of claim 1, wherein the extraction module is configured for extraction of a target species from a fluid, wherein the target species is a metal ion, a metal complex, a metal-containing compound, or a combination thereof.

23. The extraction module of claim 1, further comprising an inlet capable of providing the fluid comprising the target species to the module, and an outlet capable of removing a target species-depleted fluid from the module.

24. The extraction module of claim 23, wherein
the inlet is in fluid communication with a stack of extraction leaves; and
the outlet is in fluid communication with the axial chamber.

25. The extraction module of claim 23, wherein
the inlet is in fluid communication with the axial chamber; and
the outlet is in fluid communication with a stack of extraction leaves.

26. The extraction module of claim 23, comprising a first inlet capable of providing a feed stream to the extraction module and a second inlet capable of providing a stripping solution capable of regenerating the extraction module.

27. The extraction module of claim 23, wherein the extraction leaf is connected to the central axial chamber by direct insertion into an opening extending through a wall of the axial chamber, wherein
the opening is oriented perpendicular to the chamber wall, or
the opening is oriented at an angle that is greater than 0° and less than 90° relative to the chamber wall.

28. The extraction module of claim 23, wherein the extraction leaf is connected to the central axial chamber by an adapter.

29. An apparatus for extraction of a target species comprising the extraction module of claim 1.

30. The apparatus of claim 29, comprising two or more of the extraction modules, wherein the extraction modules are arranged in series.

31. The apparatus of claim 30, comprising:
a first extraction module for extraction of a first target species from a fluid; and
a second extraction module for extraction of a second target species from the fluid;
wherein the first target species and the second target species are different.

32. A method for adsorption of a target species, the method comprising:
providing a fluid comprising a target species to the extraction module of claim 1;
wherein at least a portion of the target species is incorporated to the porous active layer.

33. The method of claim 32, further comprising removing a product stream from the extraction module or the apparatus, wherein the product stream has a concentration of the target species that is less than a concentration of the target species in a feed stream.

34. The method of claim 32, wherein the providing the fluid is using a continuous flow.

35. The method of claim 32, wherein the providing the fluid is using a pulsed flow.

36. The method of claim 32, wherein the fluid is provided to one or more of the extraction leaves of the extraction module and the fluid flows radially inward toward the axial chamber, and a target species depleted-fluid is removed from the module at an outlet of the axial chamber.

37. The method of claim 32, wherein the fluid is provided to an inlet of the axial chamber of the extraction module and the fluid flows radially outward toward a periphery of the module, and a target species depleted-fluid is removed from the module at an outlet in fluid communication with the extraction leaves.

38. The method of claim 32, further comprising further comprising releasing captured target species from the extraction leaf and optionally regenerating the extraction module.

39. The method of claim 36, wherein releasing captured target species from the extraction leaf comprises providing a stripping solution to the extraction module, wherein the stripping solution is effective to release the incorporated target species from the porous active layer to provide a second product stream comprising the target species.

40. The method of claim 36, wherein regenerating the extraction module further comprises applying a current to the extraction module.
